(19) United States
(12) Patent Application Publication
(10) Pub. No.: US 2025/0126236 A1
(43) Pub. Date: Apr. 17, 2025

(54) ELECTRONIC DEVICE AND CONTROL METHOD THEREFOR

(71) Applicant: SAMSUNG ELECTRONICS CO., LTD., Suwon-si (KR)

(72) Inventors: Sangki YOON, Suwon-si (KR); Kibum Seong, Suwon-si (KR); Bonseuk Goo, Suwon-si (KR); Youngtae Kim, Suwon-si (KR); Byungseok Soh, Suwon-si (KR); Kisung Lee, Suwon-si (KR); Youngchol Lee, Suwon-si (KR); Weonhee Lee, Suwon-si (KR)

(73) Assignee: SAMSUNG ELECTRONICS CO., LTD., Suwon-si (KR)

(21) Appl. No.: 18/999,397

(22) Filed: Dec. 23, 2024

Related U.S. Application Data
(63) Continuation of application No. PCT/KR2023/005676, filed on May 26, 2023.

(30) Foreign Application Priority Data
Jun. 23, 2022 (KR) 10-2022-0077142
Sep. 7, 2022 (KR) 10-2022-0113427

(51) Int. Cl. H04N 9/31; G06F 3/01

(52) U.S. Cl. CPC H04N 9/3194; G06F 3/013; G06F 3/017; H04N 9/317; H04N 9/3185

(57) ABSTRACT

An electronic device may include: a projector; at least one sensor; at least one processor; memory storing instructions that, when executed by the at least one processor, cause the at least one processor to: identify a user gaze based on first sensing data obtained through the at least one sensor; divide a projection image stored in the memory into a first image region corresponding to the user gaze and a second image region which is a remaining region other than the first image region; modify the projection image to include the first image region of a first luminance value and the second image region of a second luminance value different from the first luminance value; and control the projector to project the modified projection image.

### CROSS-REFERENCE TO RELATED APPLICATIONS

This application is a bypass continuation of International Application No. PCT/KR2023/005676, filed on Apr. 26, 2023, which is based on and claims priority to Korean Patent Application No. 10-2022-0077142, filed on Jun. 23, 2022, and Korean Patent Application No. 10-2022-0113427, filed on Sep. 7, 2022, in the Korean Intellectual Property Office, the disclosures of which are incorporated by reference herein in their entireties.

### BACKGROUND

### 1. Field

The disclosure relates to an electronic device and a control method therefor. Specifically, the disclosure relates to an electronic device that controls the brightness of a projected image based on a user gaze, and a control method therefor.

### 2. Description of Related Art

In case power of an electronic device projecting images (e.g., a projector) is not connected, a user may stop viewing of a content for charging. To avoid stopping viewing, a power supply device that can be connected via wire should be located.

However, in the case of a portable electronic device, a power supply device that can be immediately connected via wire may not exist in the surroundings. Accordingly, the electronic device needs to effectively control power as much as possible.

Lowering a luminance value of a projected image may save power. However, in case that a luminance value of an entire image is lowered, it may interfere with the user's viewing.

### SUMMARY

The disclosure was devised for improving the aforementioned problem, and the purpose of the disclosure is in providing an electronic device that performs control such that an area corresponding to a user gaze is projected to be bright, and a control method therefor.

According to an aspect of the disclosure, an electronic device may include: a projector; at least one sensor; at least one processor; memory storing instructions that, when executed by the at least one processor, cause the at least one processor to: identify a user gaze based on first sensing data obtained through the at least one sensor; divide a projection image stored in the memory into a first image region corresponding to the user gaze and a second image region which is a remaining region other than the first image region; modify the projection image to include the first image region of a first luminance value and the second image region of a second luminance value different from the first luminance value; and control the projector to project the modified projection image.

The instructions may further cause the at least one processor to: identify a projection region; divide the projection region into a first projection region corresponding to the user gaze and a second projection region which is a remaining region other than the first projection region; and divide the projection image into the first image region corresponding to the first projection region and the second image region corresponding to the second projection region.

The instructions may further cause the at least one processor to: identify the projection region based on second sensing data obtained through the at least one sensor; and identify the first projection region based on a position corresponding to the user gaze and a predetermined distance.

The at least one sensor may include an image sensor and a distance sensor, the first sensing data may be data obtained through the image sensor, and the second sensing data may be data obtained through the distance sensor.

The instructions may further cause the at least one processor to: categorize the projection region into a plurality of groups; and categorize the plurality of groups such that a first group corresponding to the user gaze is categorized as the first projection region and a remaining group other than the first group is categorized as the second projection region.

The instructions may further cause the at least one processor to: based on the user gaze not corresponding to the projection region, change a projection direction based on the user gaze; and recategorize the projection region based on the changed projection direction.

The instructions may further cause the at least one processor to: based on the user gaze not corresponding to the projection region, determine whether a predetermined object is identified; and based on the predetermined object being identified, categorize a region corresponding to the predetermined object in the projection region as the first projection region.

The instructions may further cause the at least one processor to: based on the user gaze being changed, divide the projection image into a third image region corresponding to the changed user gaze and a fourth image region which is a remaining region other than the third image region; and modify the projection image to include the third image region of the first luminance value and the fourth image region of the second luminance value.

The instructions may further cause the at least one processor to: based on identifying a plurality of user gazes including a first user gaze and a second user gaze, modify the projection image such that a luminance value of an image region corresponding to the first user gaze and a luminance value of an image region corresponding to the second user gaze are different.

The instructions may further cause the at least one processor to: identify a user gesture based on the first sensing data; and modify the projection image such that a luminance value of an image region corresponding to the user gaze and a luminance value of an image region corresponding to the user gesture are different.

According to an aspect of the disclosure, a method for controlling an electronic device, may include: identifying a user gaze based on first sensing data; dividing a projection image stored in the electronic device into a first image region corresponding to the user gaze and a second image region which is a remaining region other than the first image region; modifying the projection image to include the first image region of a first luminance value and the second image region of a second luminance value different from the first luminance value; and projecting the modified projection image.

The method may further include: identifying a projection region; and dividing the projection region into a first projection region corresponding to the user gaze and a second projection region which is a remaining region other than the first projection region. The dividing the projection image may include dividing the projection image into the first image region corresponding to the first projection region and the second image region corresponding to the second projection region.

The method may further include identifying the projection region based on second sensing data. The dividing the projection region may include identifying the first projection region based on a position corresponding to the user gaze and a predetermined distance.

The first sensing data may be obtained through an image sensor, and the second sensing data may be obtained through a distance sensor.

The dividing the projection region may include: categorizing the projection region into a plurality of groups; and categorizing the plurality of groups such that a first group corresponding to the user gaze is categorized as the first projection region and a remaining group other than the first group is categorized as the second projection region.

According to an aspect of the disclosure, an electronic device may include: a projector; at least one sensor; at least one processor; memory storing instructions that, when executed by the at least one processor, cause the at least one processor to: identify a user gaze based on first sensing data obtained through the at least one sensor; based on identifying a first user gaze and a second user gaze, divide a projection image stored in the memory into a first image region corresponding to the first user gaze, a second image region corresponding to the second user gaze, and a third image region which is a remaining region other than the first image region and the second image region; modify the projection image such that luminance values of the first image region and the second image region are higher than a luminance value of the third image region; and control the projector to project the modified projection image.

### BRIEF DESCRIPTION OF THE DRAWINGS

Above and other aspects, features, and advantages of certain embodiments of the present disclosure will be more apparent from the following description taken in conjunction with the accompanying drawings, in which:

FIG. 1 is a perspective view illustrating an exterior of an electronic device according to one or more embodiments;

FIG. 2 is a block diagram illustrating a configuration of an electronic device according to one or more embodiments;

FIG. 3 is a block diagram illustrating in detail a configuration of the electronic device in FIG. 2 according to one or more embodiments;

FIG. 4 is a perspective view illustrating an exterior of an electronic device according to one or more embodiments;

FIG. 5 is a perspective view illustrating an exterior of an electronic device according to one or more embodiments;

FIG. 6 is a diagram for illustrating rotation information of an electronic device according to one or more embodiments;

FIG. 7 is a diagram for illustrating rotation information of a projection surface according to one or more embodiments;

FIG. 8 is a diagram for illustrating an operation of projecting some regions of a projection image to be bright based on a user gaze according to one or more embodiments;

FIG. 9 is a diagram for illustrating an operation of making a luminance value of a region not corresponding to a user gaze small based on a luminance value of a projection image according to one or more embodiments;

FIG. 10 is a diagram for illustrating an operation of making a luminance value of a region corresponding to a user gaze big based on a luminance value of a projection image according to one or more embodiments;

FIG. 11 is a diagram for illustrating movement of a region corresponding to a user gaze in an up-down direction according to one or more embodiments;

FIG. 12 is a diagram for illustrating an electronic device communicating with a server according to one or more embodiments;

FIG. 13 is a diagram for illustrating an electronic device communicating with a terminal device according to one or more embodiments;

FIG. 14 is a flow chart for illustrating an operation of correcting a luminance value of a projection image based on a user gaze according to one or more embodiments;

FIG. 15 is a flow chart for illustrating in detail the operation in FIG. 14 according to one or more embodiments;

FIG. 16 is a flow chart for illustrating an operation of changing a user gaze according to one or more embodiments;

FIG. 17 is a flow chart for illustrating an operation of obtaining projection images of which luminance values are different based on a user gaze according to one or more embodiments;

FIG. 18 is a diagram for illustrating an operation of dividing a projection region based on a position of a user gaze and a predetermined distance according to one or more embodiments;

FIG. 19 is a flow chart for illustrating an operation of dividing a projection region based on a position of a user gaze and a predetermined distance according to one or more embodiments;

FIG. 20 is a diagram for illustrating an operation of dividing a projection region into groups of a predetermined number according to one or more embodiments;

FIG. 21 is a flow chart for illustrating an operation of dividing a projection region into groups of a predetermined number according to one or more embodiments;

FIG. 22 is a diagram for illustrating an operation of dividing a projection region based on boundary lines according to one or more embodiments;

FIG. 23 is a flow chart for illustrating an operation of dividing a projection region based on boundary lines according to one or more embodiments;

FIG. 24 is a flow chart for illustrating an operation of dividing a projection region based on a moving speed of a user gaze according to one or more embodiments;

FIG. 25 is a diagram for illustrating an operation of identifying whether a user gaze is beyond a projection region according to one or more embodiments;

FIG. 26 is a flow chart for illustrating an operation of identifying whether a user gaze is beyond a projection region according to one or more embodiments;

FIG. 27 is a diagram for illustrating an operation of changing a luminance value according to movement of a user gaze according to one or more embodiments;

FIG. 28 is a diagram for illustrating an operation of changing a luminance value according to a plurality of user gazes according to one or more embodiments;

FIG. 29 is a flow chart for illustrating an operation of changing a luminance value according to a plurality of user gazes according to one or more embodiments;

FIG. 30 is a diagram for illustrating an operation of changing luminance values of some contents as a multi-view function is performed according to one or more embodiments;

FIG. 31 is a flow chart for illustrating an operation of changing luminance values of some contents as a multi-view function is performed according to one or more embodiments;

FIG. 32 is a diagram for illustrating an operation of changing luminance values of some contents as a multi-view function is performed with a plurality of devices according to one or more embodiments;

FIG. 33 is a flow chart for illustrating an operation of changing luminance values of some contents as a multi-view function is performed with a plurality of devices according to one or more embodiments;

FIG. 34 is a diagram for illustrating an operation of providing a gradation effect to boundaries of divided image regions according to one or more embodiments;

FIG. 35 is a diagram for illustrating an operation of projecting a frame of the current time point and a frame of a past time point simultaneously according to one or more embodiments;

FIG. 36 is a diagram for illustrating an operation of changing a luminance value by identifying an object according to one or more embodiments;

FIG. 37 is a flow chart for illustrating an operation of changing a luminance value by identifying an object according to one or more embodiments;

FIG. 38 is a diagram for illustrating an operation of changing a luminance value based on a user gesture according to one or more embodiments;

FIG. 39 is a diagram for illustrating an operation of changing a luminance value based on a user gesture according to one or more embodiments;

FIG. 40 is a flow chart for illustrating an operation of changing a luminance value based on a user gesture according to one or more embodiments;

FIG. 41 is a diagram for illustrating an operation of changing a size of a divided image region based on a user gesture according to one or more embodiments;

FIG. 42 is a flow chart for illustrating an operation of changing a size of a divided image region based on a user gesture according to one or more embodiments; and

FIG. 43 is a flow chart for illustrating a control method of an electronic device according to one or more embodiments.

### DETAILED DESCRIPTION

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art who work in the pertinent field, previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may be used to describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, singular expressions include plural expressions, unless defined obviously differently in the context. Also, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the disclosure, “a module” or “a part” performs at least one function or operation, and may be implemented as hardware or software, or as a combination of hardware and software. Also, a plurality of “modules” or “parts” may be integrated into at least one module and implemented as at least one processor, except “a module” or “a part” that needs to be implemented as specific hardware.

Further, in this specification, the term “user” may refer to a person who uses an electronic device or a device using an electronic device (e.g.: an artificial intelligence electronic device).

Hereinafter, an embodiment of the disclosure will be described in more detail with reference to the accompanying drawings.

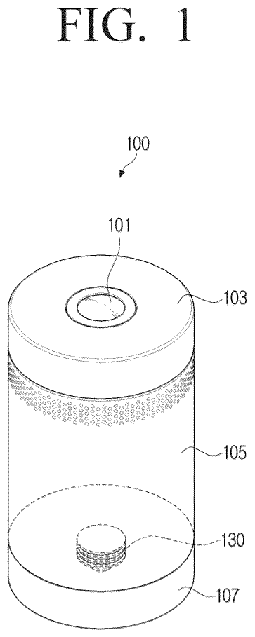

FIG. 1 is a perspective view illustrating an exterior of an electronic device 100 according to one or more embodiments.

Referring to FIG. 1, an electronic device 100 may include a projection lens 101, a head 103, a main body 105, a cover 107, or a connector 130.

The electronic device 100 may be devices in various forms. In particular, the electronic device 100 may be a projector device that enlarges and projects an image to a wall or a screen, and the projector device may be a liquid crystal display (LCD) projector or a digital light processing (DLP) type projector that uses a digital micromirror device (DMD).

In addition, the electronic device 100 may be a home or industrial display device, or an illumination device used in daily life, or an audio device including an audio module. The electronic device 100 may be implemented as a portable communication device (e.g.: a smartphone), a computer device, a portable multimedia device, a wearable device, or a home appliance device, and the like. Meanwhile, the electronic device 100 according to one or more embodiments of the disclosure is not limited to the above-described device, and may be implemented as an electronic device 100 equipped with two or more functions of the above-described devices. For example, the electronic device 100 may be utilized as a display device, an illumination device, or an audio device as its projector function is turned off and its illumination function or a speaker function is turned on according to a manipulation of a processor, or may be utilized as an artificial intelligence (AI) speaker as it includes a microphone or a communication device.

The projection lens 101 may be formed on one surface of the main body 105, and project a light that passed through a lens array to the outside of the main body 105. The projection lens 101 according to the one or more embodiments of the disclosure may be an optical lens that was low-dispersion coated for reducing chromatic aberration. The projection lens 101 may be a convex lens or a condensing lens, and the projection lens 101 according to the one or more embodiments of the disclosure may adjust a focus by adjusting positions of a plurality of sub lenses.

The head 103 may be provided to be coupled to one surface of the main body 105 and support and protect the projection lens 101. The head 103 may be coupled to the main body 105 to be swiveled within a predetermined angle range based on one surface of the main body 105.

The head 103 may be automatically or manually swiveled by the user or the processor and freely adjust a projection angle of the projection lens 101. Alternatively, the head 103 may include a neck that is coupled to the main body 105 and extends from the main body 105, and the head 103 may thus adjust the projection angle of the projection lens 101 by being tilted backward or forward.

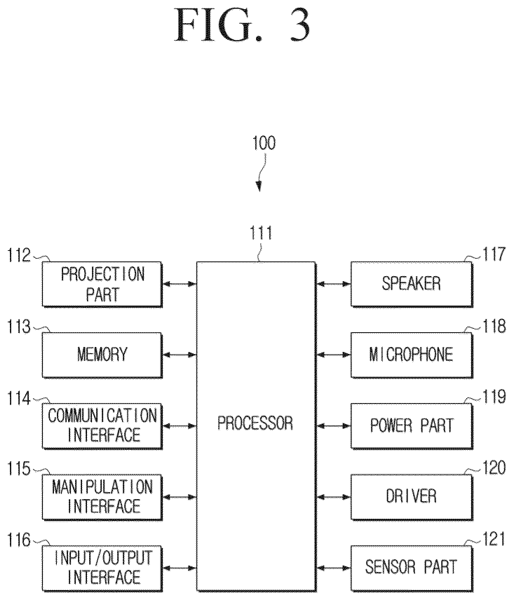

The main body 105 is a housing constituting the exterior, and may support or protect components of the electronic device 100 (e.g., components illustrated in FIG. 3) that are arranged inside the main body 105. The shape of the main body 105 may be a structure close to a cylindrical shape as illustrated in FIG. 1. However, the shape of the main body 105 is not limited thereto, and according to one or more embodiments of the disclosure, the main body 105 may be implemented in various geometrical shapes such as a column having polygonal cross sections, a cone, or a sphere.

The main body 105 may have a size enabling it to be gripped or moved by a user with his/her one hand, or may be implemented in a micro size enabling it to be easily carried by the user or implemented in a size enabling it to be held on a table or coupled to the illumination device.

The material of the main body 105 may be implemented as matt metal or a synthetic resin such that the user's fingerprint or dust is not smeared. Alternatively, the exterior of the main body 105 may consist of a slick glossy material.

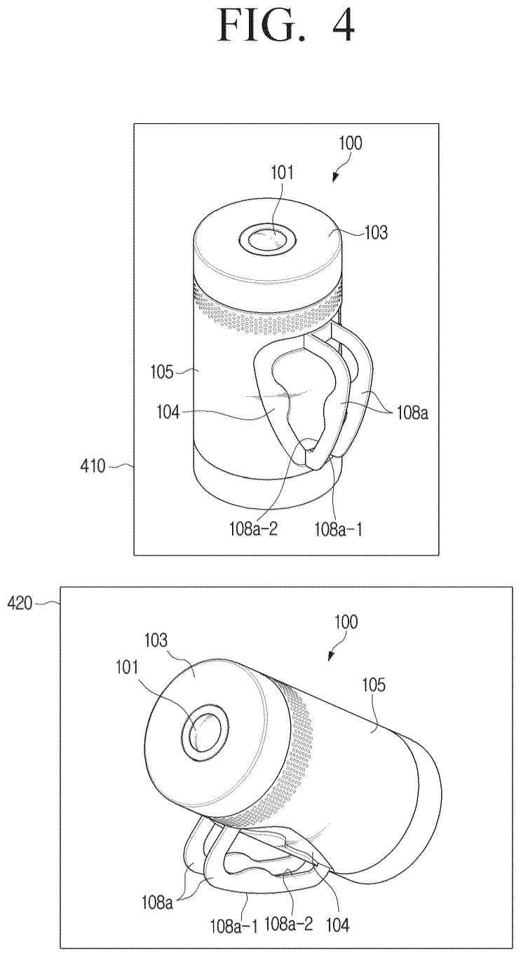

In a partial area of the exterior of the main body 105, a friction area may be formed for the user to grip and move the main body 105. Alternatively, in at least a partial area of the main body 105, a bent gripping part or a support 108a (refer to FIG. 4) that the user can grip may be provided.

The electronic device 100 may project a light or an image to a desired position by adjusting a projection angle of the projection lens 101 while adjusting a direction of the head 103 in a state where the position and angle of the main body 105 are fixed. In addition, the head 103 may include a handle that the user may grip after rotating the head in a desired direction.

A plurality of openings may be formed in an outer circumferential surface of the main body 105. Through the plurality of openings, audio output from an audio outputter may be output to the outside of the main body 105 of the electronic device 100. The audio outputter may include a speaker, and the speaker may be used for general uses such as reproduction of multimedia or reproduction of recording, and output of a voice, etc.

According to the one or more embodiments of the disclosure, the main body 105 may include a radiation fan provided therein, and when the radiation fan is operated, air or heat inside the main body 105 may be discharged through the plurality of openings. Accordingly, the electronic device 100 may discharge heat generated by driving of the electronic device 100 to the outside, and prevent overheating of the electronic device 100.

The connector 130 may connect the electronic device 100 with an external device to transmit or receive electric signals, or receive power from the external device. The connector 130 according to the one or more embodiments of the disclosure may be physically connected with the external device. Here, the connector 130 may include an input/output interface, and connect its communication with the external device in a wired or wireless manner or receive power from the external device. For example, the connector 130 may include a high definition multimedia interface (HDMI) connection terminal, a universal serial bus (USB) connection terminal, a secure digital (SD) card accommodating groove, an audio connection terminal, or a power consent. Alternatively, the connector 130 may include a Bluetooth, wireless-fidelity (Wi-Fi), or a wireless charge connection module, which are connected with the external device in a wireless manner.

In addition, the connector 130 may have a socket structure connected to an external illumination device, and may be connected to a socket accommodating groove of the external illumination device to receive power. The size and specification of the connector 130 having the socket structure may be implemented in various ways in consideration of an accommodating structure of an external device that may be coupled thereto. For example, a diameter of a joining portion of the connector 130 may be implemented as 26 mm according to an international standard E26, and in this case, the electronic device 100 may be coupled to an external illumination device such as a stand in place of a light bulb that is generally used. Meanwhile, when being fastened to a conventional socket positioned on a ceiling, the electronic device 100 may be projected from the upper side to the lower side, and in case the electronic device 100 does not rotate due to socket coupling, the screen cannot be rotated, either. Accordingly, in order that the electronic device 100 can rotate even when it is socket-coupled and receives power, the head 103 of the electronic device 100 may adjust a projection angle by being swiveled on one surface of the main body 105 while the electronic device 100 is socket-coupled to a stand on the ceiling, allowing the electronic device 100 to project a screen or rotate a screen to a desired position.

The connector 130 may include a coupling sensor, and the coupling sensor may detect whether the connector 130 and an external device are coupled, the coupling state, or a coupling target, and transmit the same to the processor, and the processor may control the driving of the electronic device 100 based on the transmitted detection values.

The cover 107 may be coupled to or separated from the main body 105, and protect the connector 130 such that it is not exposed to the outside at all times. The shape of the cover 107 may be a shape continued from the main body 105 as illustrated in FIG. 1, or may be implemented to correspond to the shape of the connector 130. The cover 107 may support the electronic device 100, and the electronic device 100 may be used by being coupled to or held on an external holder while being coupled to the cover 107.

In the electronic device 100 according to the one or more embodiments of the disclosure, a battery may be provided inside the cover 107. The battery may include, for example, a primary cell that cannot be recharged, a secondary cell that may be recharged, or a fuel cell.

The electronic device 100 may include a camera module, and the camera module may capture a still image or a video. According to the one or more embodiments of the disclosure, the camera module may include at least one lens, an image sensor, an image signal processor, or a flash.

Also, the electronic device 100 may include a protection case for the electronic device 100 to be easily carried while being protected. Alternatively, the electronic device 100 may include a stand that supports or fixes the main body 105, and a bracket that can be coupled to a wall surface or a partition.

In addition, the electronic device 100 may be connected with various external devices by using its socket structure, and provide various functions. According to the one or more embodiments of the disclosure, the electronic device 100 may be connected to an external camera device by using the socket structure. The electronic device 100 may provide an image stored in the connected camera device or an image that is currently being captured using a projecting part 112. As another example, the electronic device 100 may be connected to a battery module by using its socket structure to receive power. Meanwhile, the electronic device 100 may be connected to an external device by using its socket structure, but this is merely one of various examples, and the electronic device 100 may be connected an external device by using another interface (e.g., a USB, etc.).

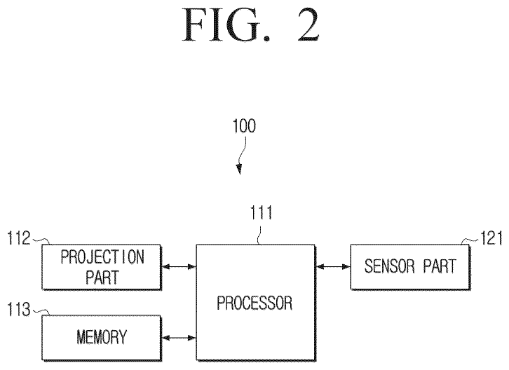

FIG. 2 is a block diagram illustrating a configuration of the electronic device 100 according to one or more embodiments.

Referring to FIG. 2, the electronic device 100 may include at least one processor 111, a projection part 112 (projector), memory 113, and a sensor part 121 (at least one sensor).

The at least one processor 111 may perform overall control operations of the electronic device 100. Specifically, the at least one processor 111 performs a function of controlling the overall operations of the electronic device 100. Detailed explanation related to the at least one processor 111 will be described in FIG. 3.

The projection part 112 is a component that projects an image (a projection image, a content, etc.) to the outside. Detailed explanation related to the projection part 112 will be described in FIG. 3.

The memory 113 may store a projection image projected through the projection part 112. Here, the projection image may mean not only a still image but also consecutive images (or moving images). The projection image may also mean an image included in a content.

The sensor part 121 may include a plurality of sensors. Here, the sensor part 121 may include at least one of a first sensor or a second sensor. The first sensor may mean an image sensor. Here, the image sensor may mean a camera that obtains photographing (or image) data, etc. Here, the second sensor may mean a distance sensor. The distance sensor may mean a Time of Flight (ToF) sensor or a LiDAR sensor, etc.

The at least one processor 111 may identify a user gaze based on sensing data obtained through the sensor part 121, and divide a projection image stored in the memory 113 into a first image region corresponding to the user gaze and a second image region which is the remaining region other than the first image region, obtain the projection image including the first image region of a first luminance value and the second image region of a second luminance value different from the first luminance value, and control the projection part 112 to project the obtained projection image.

The at least one processor 111 may obtain sensing data through the sensor part 121.

According to one or more embodiments, the at least one processor 111 may obtain first sensing data and second sensing data according to a time point of obtaining data. For example, data obtained on a first time point may be described as the first sensing data, and data obtained on a second time point may be described as the second sensing data.

According to one or more embodiments, the at least one processor 111 may obtain the first sensing data and the second sensing data according to the type of a sensor that senses sensing data. For example, data received through a first sensor may be described as the first sensing data, and data received through a second sensor may be described as the second sensing data.

The at least one processor 111 may obtain a gaze of the user 20 based on sensing data obtained through an image sensor. The existence of the user 20 itself may be identified by an image sensor or a distance sensor, etc. Meanwhile, the at least one processor 111 may determine which position the user 20 is viewing based on sensing data obtained through the image sensor.

The at last one processor 111 may identify whether the user 20 exists based on sensing data obtained through the sensor part (including at least one of the image sensor or the distance sensor). In case the user 20 exists, the at least one processor 111 may identify a gaze of the user 20 (referred to as a user gaze hereinafter). The user gaze may indicate which position the user 20 is viewing in a projection region wherein a projection image is output.

The at least one processor 111 may obtain sensing data including a captured image including the face of the user 20. Here, the at least one processor 111 may analyze where the user 20 is looking by recognizing the pupils (or the irises) of the user 20 included in the image. Also, the at least one processor 111 may analyze a user gaze based on the position of the electronic device 100, a region wherein a projection image is projected, a captured image including the user 20, and position information of the user 20.

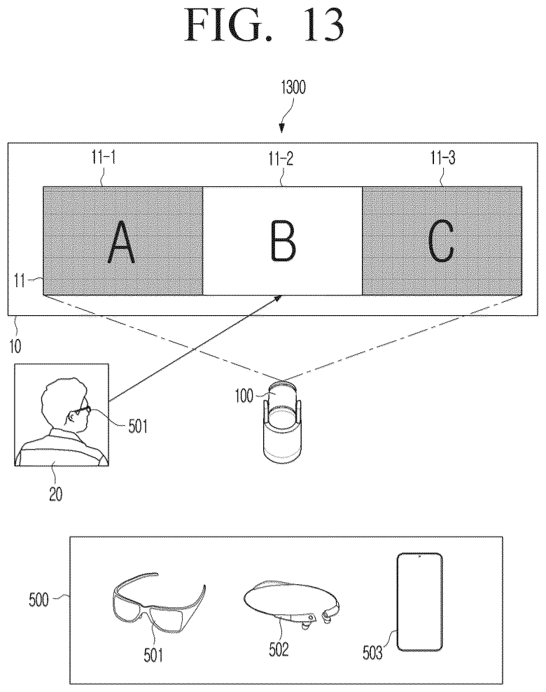

According to one or more embodiments, a user gaze may be obtained based on sensing data obtained at a terminal device 500. A sensor included in the terminal device 500 may sense information related to the user 20, and transmit the sensing data to the electronic device 100. The electronic device 100 may obtain a user gaze based on the sensing data received from the terminal device 500. Explanation in this regard will be described in FIG. 13.

Here, the at least one processor 111 may analyze which region in the projection image the user gaze is viewing.

In an embodiment wherein a projection image is being projected, the at least one processor 111 may divide the entire region of a projection image projected on a projection surface 10 into a first image region corresponding to a user gaze and a second image region not corresponding to the user gaze.

The first image region may be described as a main region, and the second image region may be described as a subsidiary region.

In an embodiment wherein a projection image is not being projected, the at least one processor 111 may divide the entire projection region wherein a projection image will be projected on the projection surface 10 into a first projection region corresponding to a user gaze and a second projection region not corresponding to the user gaze. Here, the first projection region may be a region wherein the first image region in the projection image will be projected. The second projection region may be a region wherein the second image region in the projection image will be projected. Here, the first projection region may be described as a main screen, and the second projection region may be described as a subsidiary screen.

Here, the at least one processor 111 may identify the first image region corresponding to the user gaze and the second image region not corresponding to the user gaze. The at least one processor 111 may control the projection part 112 such that the first image region is projected to be brighter than the second image region.

Specifically, the at least one processor 111 may perform an image correcting function for making a specific region (the first image region corresponding to the user gaze) bright.

The at least one processor 111 may perform an image correcting operation based on a basic luminance value (or an average luminance value) included in an original projection image.

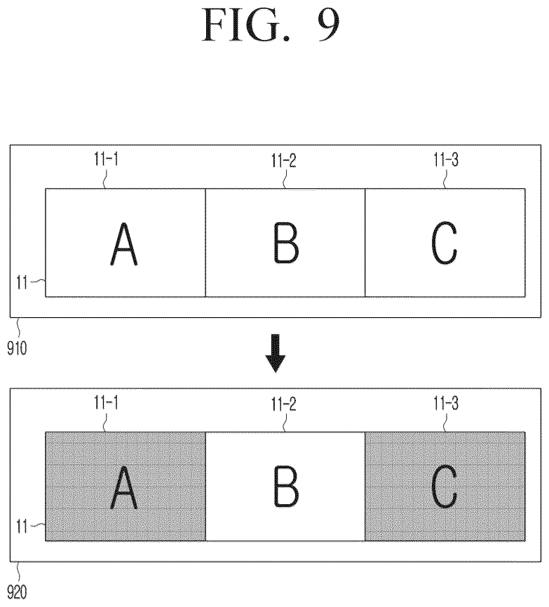

According to one or more embodiments, the at least one processor 111 may maintain the basic luminance value for the first image region corresponding to a user gaze, and change the luminance value of the second image region not corresponding to the user gaze to a luminance value lower than the basic luminance value. For example, the at least one processor 111 may maintain the basic luminance value (100%) for the first image region corresponding to a user gaze, and lower the luminance value of the second image region not corresponding to the user gaze based on a threshold ratio (50%). The at least one processor 111 may obtain a projection image including the first image region of the basic luminance value (100%) and the second image region of the changed luminance value (50%). Explanation in this regard will be described in FIG. 9.

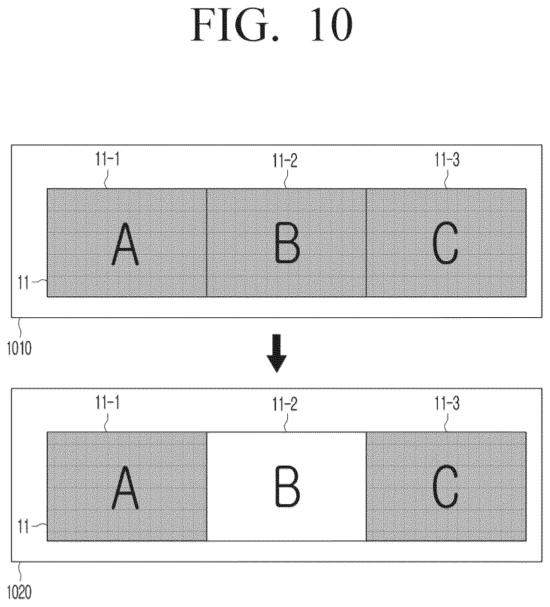

According to one or more embodiments, the at least one processor 111 may maintain the basic luminance value for the second image region not corresponding to a user gaze, and change the luminance value of the first image region corresponding to the user gaze to a luminance value higher than the basic luminance value. For example, the at least one processor 111 may maintain the basic luminance value (100%) for the second image region not corresponding to a user gaze, and heighten the luminance value of the first image region corresponding to the user gaze based on a threshold ratio (150%). The at least one processor 111 may obtain a projection image including the second image region of the basic luminance value (100%) and the first image region of the changed luminance value (150%). Explanation in this regard will be described in FIG. 10.

Here, the operation of changing a luminance value may include at least one of an operation of changing a brightness value applied to an image or an operation of changing a pixel value included in an image (e.g., R, G, B values). The operation of changing a brightness value applied to an image may mean an operation of heightening or lowering a brightness value applied to the entire projected image. The operation of changing a pixel value may mean an operation of heightening or lowering an average pixel value of the entire image to be projected.

Meanwhile, the at least one processor 111 may identify a projection region, divide the projection region into a first projection region corresponding to a user gaze and a second projection region which is the remaining region other than the first projection region, and divide a projection image into a first image region corresponding to the first projection region and a second image region corresponding to the second projection region.

Meanwhile, the at least one processor 111 may divide (categorize) a projection region into a plurality of groups, and divide (categorize) the plurality of groups such that a first group corresponding to a user gaze is divided (categorized) as the first projection region and the remaining group other than the first group is divided (categorized) as the second projection region.

A projection region may mean a region wherein a projection image is output. The at least one processor 111 may identify a projection surface 10 based on sensing data. Then, the at least one processor 111 may identify a projection region for a projection image to be projected in the entire region of the projection surface 10. Then, the at least one processor 111 may divide the projection region into a plurality of regions. Here, the plurality of regions may also be described as a plurality of groups.

The at least one processor 111 may divide the projection region into a first projection region corresponding to a user gaze and a second projection region not corresponding to the user gaze. The at least one processor 111 may analyze which region in the entire projection region the user 20 is viewing based on the user gaze.

Meanwhile, the sensing data may be first sensing data, and the at least one processor 111 may identify a projection region based on second sensing data obtained through the sensor part 121, and identify the first projection region based on a position corresponding to the user gaze and a predetermined distance.

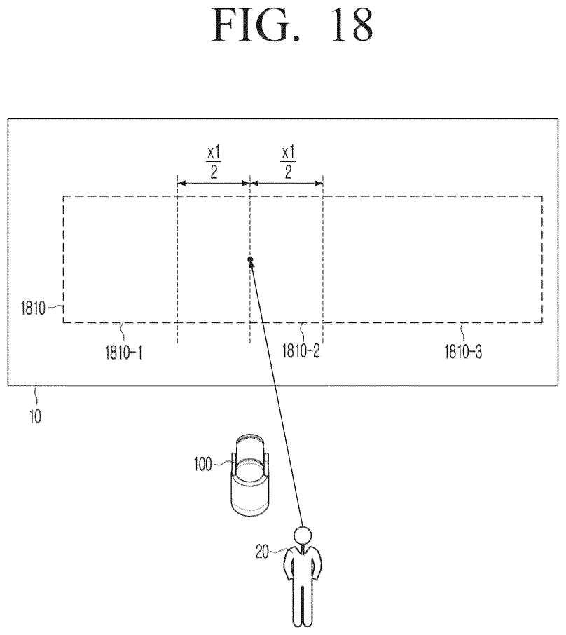

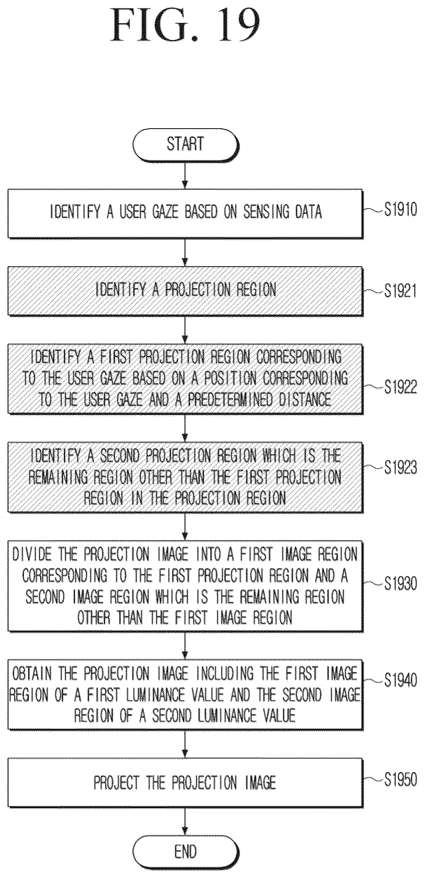

According to one or more embodiments, the at least one processor 111 may divide an entire projection region into a first projection region and a second projection region based on information related to a user gaze (a gaze direction or a gaze position) and a predetermined distance. Here, the gaze direction may indicate in which direction the gaze of the user 20 is viewing a projection region. The gaze direction may also be described as a gaze angle. The gaze position may indicate which position in a projection region the gaze of the user 20 is viewing. Detailed explanation in this regard will be described in FIG. 18 and FIG. 19.

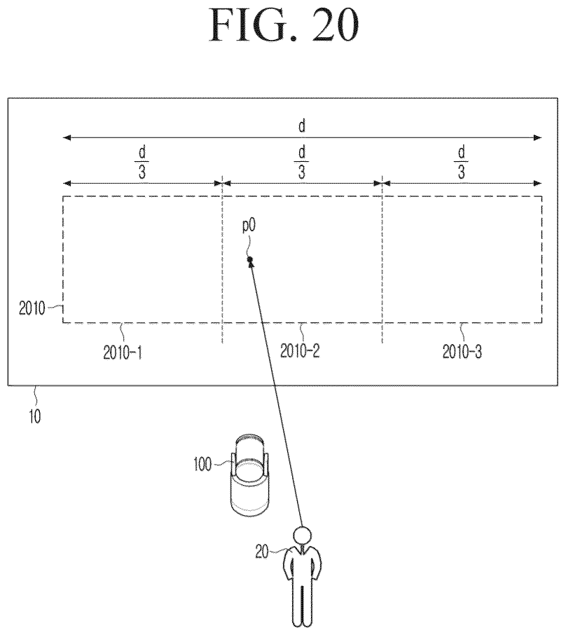

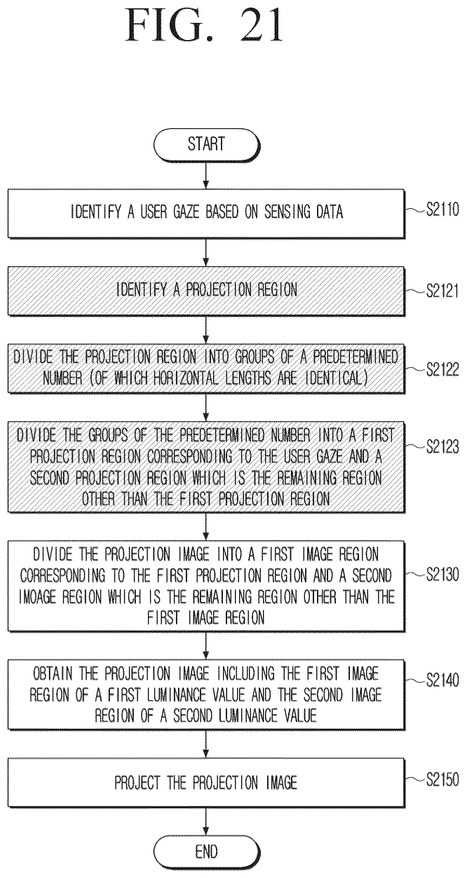

According to one or more embodiments, the at least one processor 111 may divide an entire projection region into a first projection region and a second projection region based on the number of a plurality of predetermined regions (or groups). Detailed explanation in this regard will be described in FIG. 20 and FIG. 21.

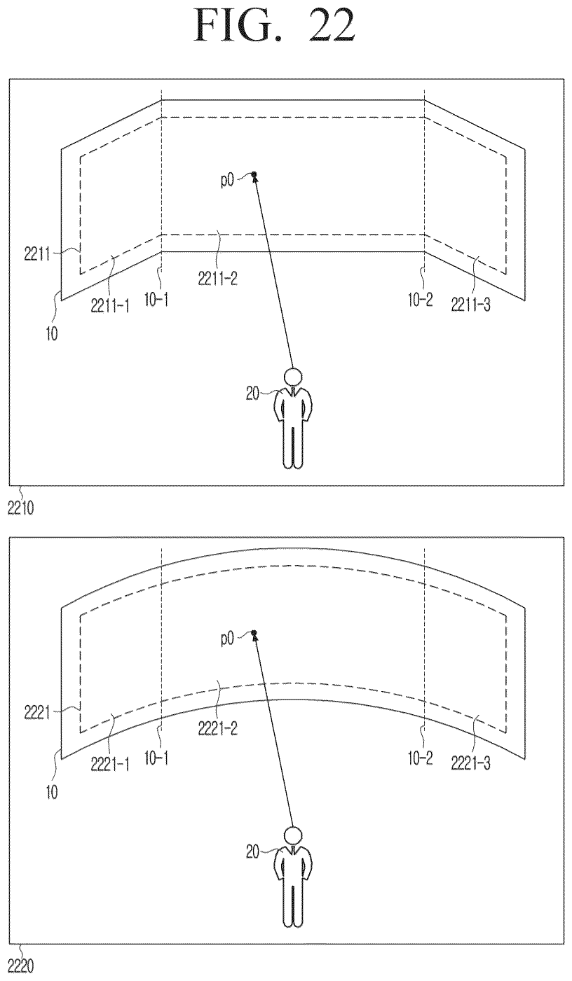

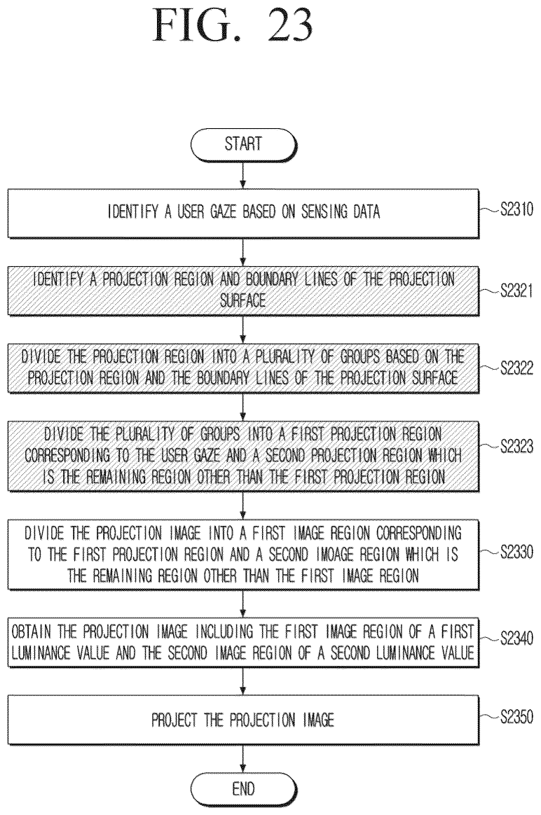

According to one or more embodiments, the at least one processor 111 may divide an entire projection region into a first projection region and a second projection region based on boundary lines included in the projection surface 10. Detailed explanation in this regard will be described in FIG. 22 and FIG. 23.

Meanwhile, the first sensing data may be data obtained through an image sensor included in the sensor part 121, and the second sensing data may be data obtained through a distance sensor included in the sensor part 121.

Here, the sensor part 121 may include at least one of a first sensor (an image sensor) for capturing an image or a second sensor (a distance sensor) for identifying a projection region.

According to one or more embodiments, the at least one processor 111 may obtain the first sensing data that is obtained through the image sensor and the second sensing data that is obtained through the distance sensor. The at least one processor 111 may perform the image correcting function by using both of the first sensing data and the second sensing data.

According to one or more embodiments, the at least one processor 111 may obtain only the first sensing data that is obtained through the image sensor. The at least one processor 111 may perform the image correcting function by using only the first sensing data.

Meanwhile, if a user gaze does not correspond to a projection region, the at least one processor 111 may change the projection direction based on the user gaze, and reidentify (recategorize) the projection region based on the changed projection direction.

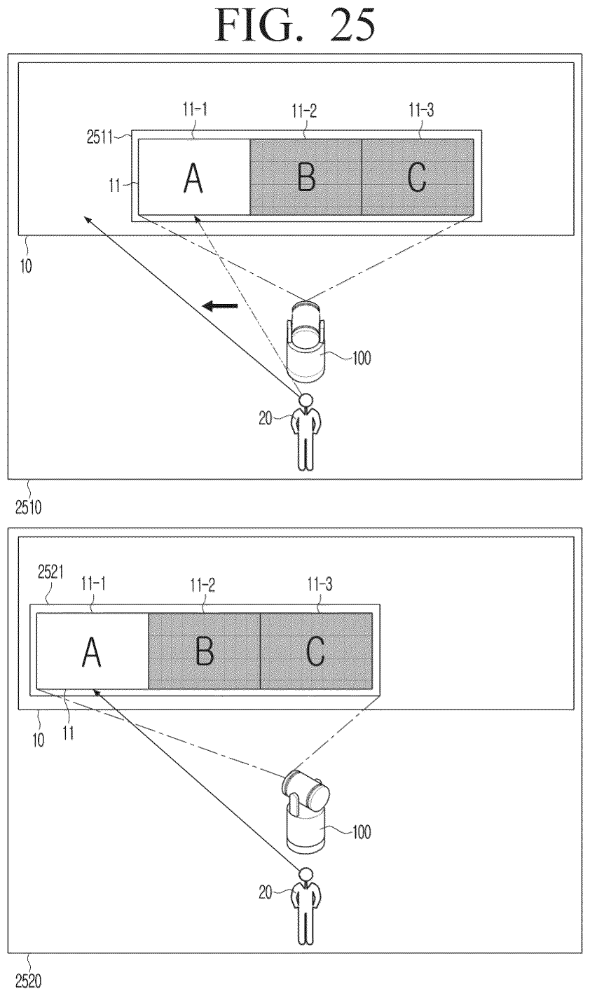

The electronic device 100 may identify a projection region based on the current arrangement position and the sensing direction of the sensor part 121. For example, in case the electronic device 100 is toward the front direction, the at least one processor 111 may identify a projection region based on the current sensing direction (the front side). The at least one processor 111 may identify whether a user gaze corresponds to the identified projection region. In case a user gaze does not correspond to the identified projection region, the at least one processor 111 may determine a region corresponding to the user gaze as a projection region. The at least one processor 111 may change a projection region that was initially identified (2511 in FIG. 25) to a projection region that was reidentified based on the user gaze (2521 in FIG. 25).

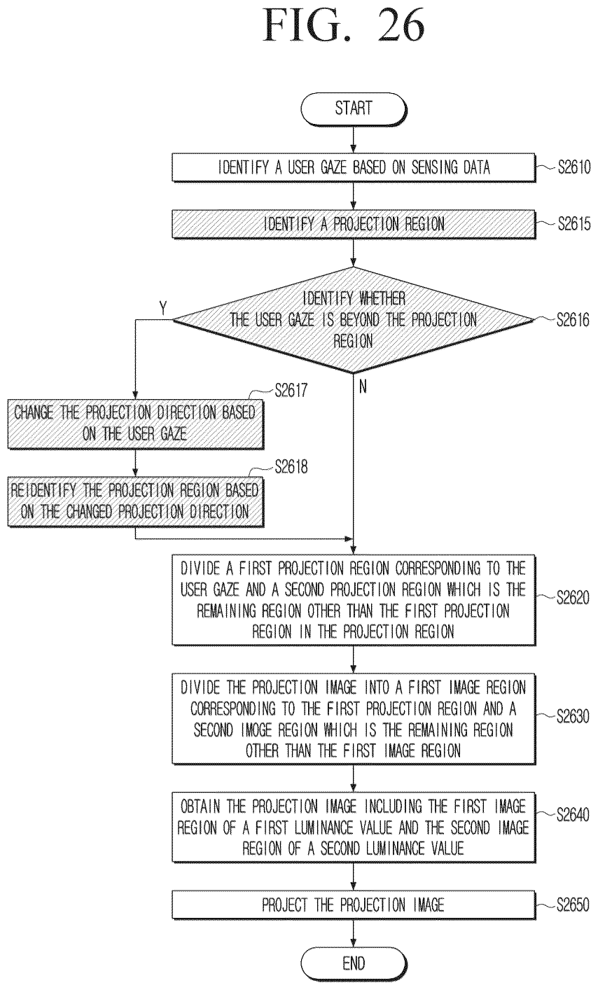

The at least one processor 111 may track a user gaze in real time. Here, the user gaze may be beyond a designated threshold range. The threshold range may mean a projection region wherein a projection image is output. In case the user gaze is beyond the projection region, the at least one processor 111 may change the projection region wherein a projection image is projected. Then, the at least one processor 111 may project a projection image on the changed projection region. Detailed explanation in this regard will be described in FIG. 25 and FIG. 26.

Meanwhile, if a user gaze does not correspond to a projection region, the at least one processor 111 may identify whether a predetermined object is identified, and if the predetermined object is identified, the at least one processor 111 may identify a region corresponding to the predetermined object in the projection region as the first projection region.

The at least one processor 111 may identify the predetermined object based on the sensing data. Here, the sensing data may mean at least one of sensing data obtained from the image sensor or sensing data obtained from the distance sensor. The predetermined object may vary according to the user setting.

The at least one processor 111 may obtain the moving direction of the predetermined object or the position of the predetermined object. The at least one processor 111 may specify a region of which brightness will be adjusted based on at least one of the moving direction of the predetermined object or the position of the predetermined object.

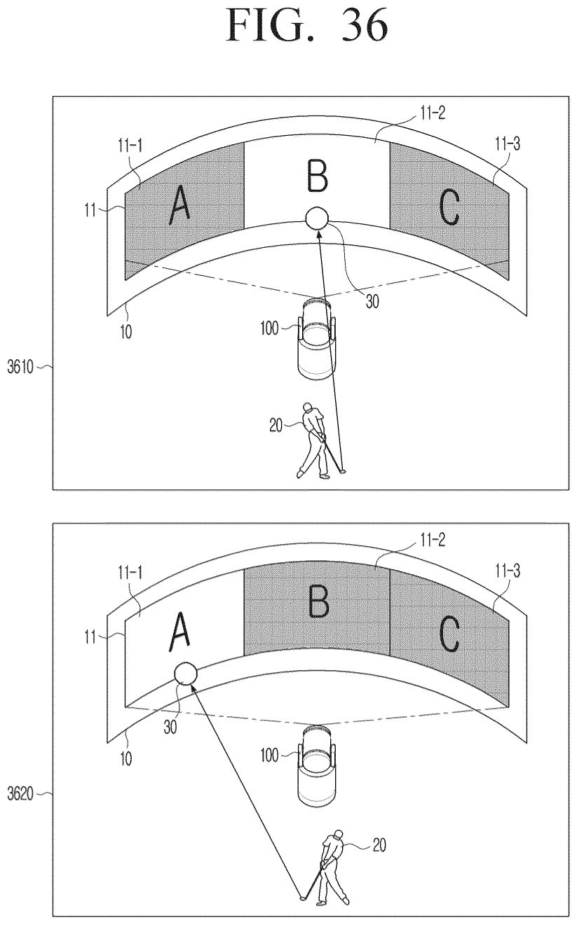

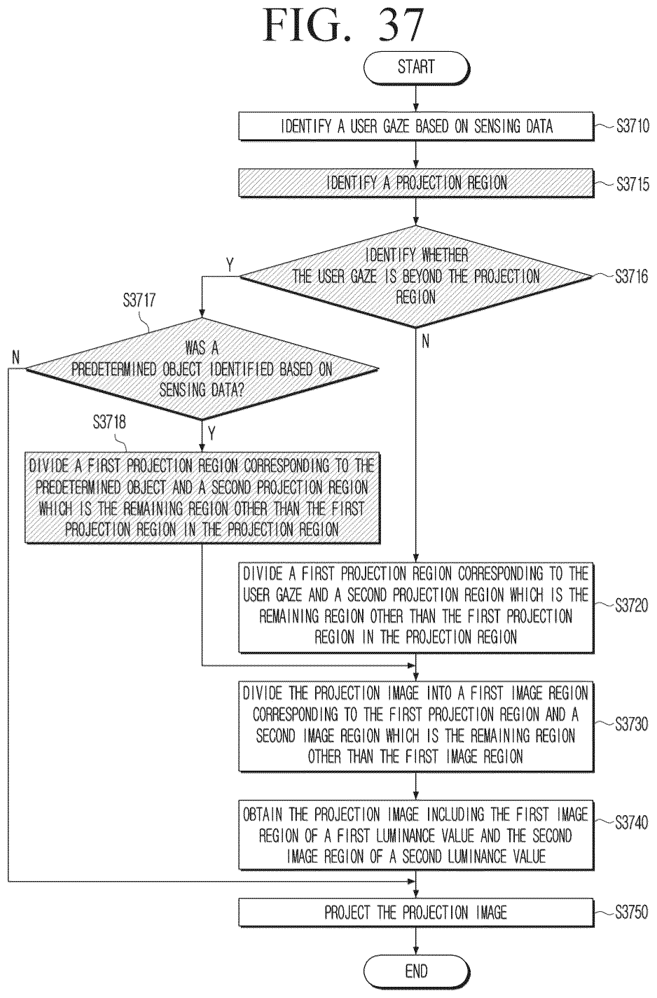

The at least one processor 111 may project a region to which the predetermined object moved or a region wherein the predetermined object is located to be brighter than the remaining region. Detailed explanation in this regard will be described in FIG. 36 and FIG. 37.

Meanwhile, if a user gaze is changed, the at least one processor 111 may divide a projection image into a third image region corresponding to the changed user gaze and a fourth image region which is the remaining region other than the third image region, and obtain a projection image including the third image region of a first luminance value and the fourth image region of a second luminance value.

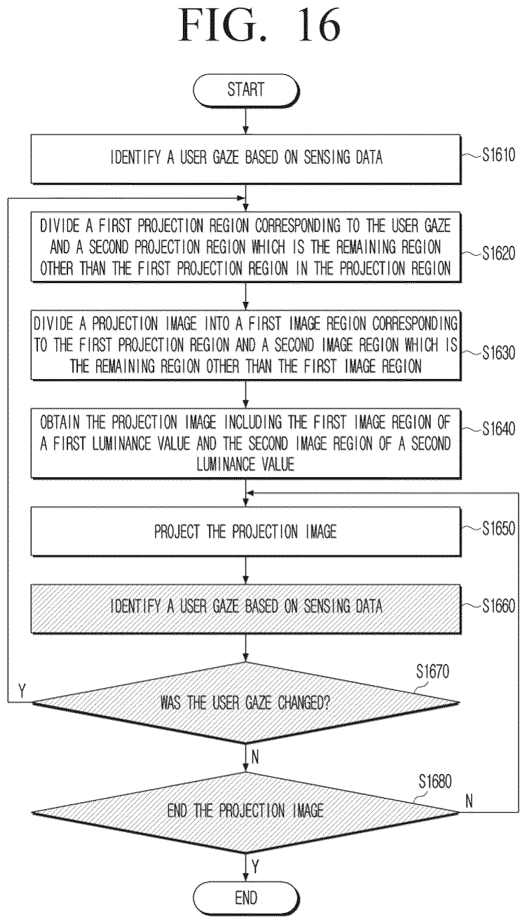

The at least one processor 111 may track a user gaze in real time. If a user gaze is changed, the at least one processor 111 may perform an operation of dividing a projection region and an operation of dividing an image region again. Detailed explanation in this regard will be described in FIG. 16.

Meanwhile, if a plurality of user gazes including a first user gaze and a second user gaze are identified, the at least one processor 111 may obtain a projection image wherein a luminance value of an image region corresponding to the first user gaze and a luminance value of an image region corresponding to the second user gaze are different.

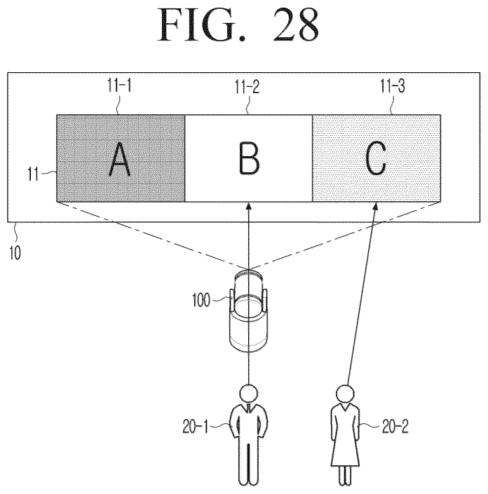

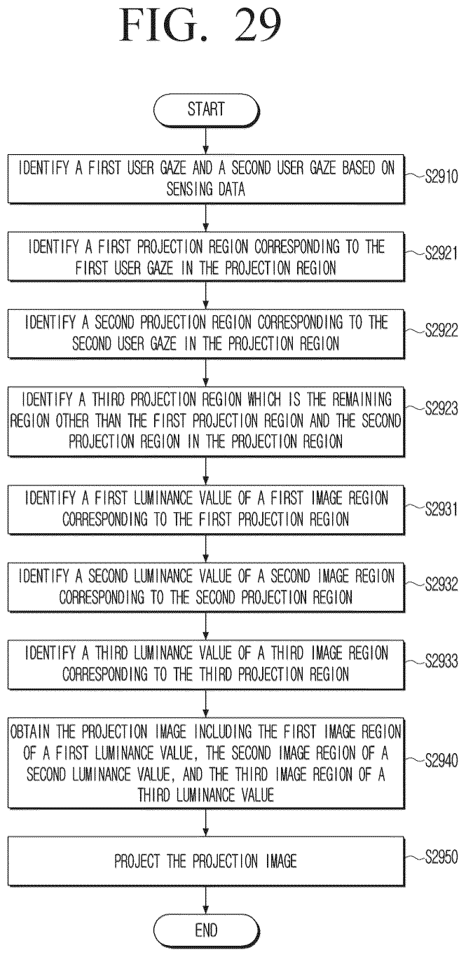

The at least one processor 111 may identify a plurality of users. The at least one processor 111 may identify gazes of each of the plurality of users. The at least one processor 111 may identify the first user gaze of the first user 20-1 and the second user gaze of the second user 20-2. Then, the at least one processor 111 may project an image region corresponding to the first user gaze in the first luminance value, and project an image region corresponding to the second user gaze in the second luminance value. Here, the first luminance value and the second luminance value may be different. Detailed explanation in this regard will be described in FIG. 28 to FIG. 29.

Meanwhile, the at least one processor 111 may identify a user gesture based on the sensing data, and obtain a projection image wherein a luminance value of an image region corresponding to a user gaze and a luminance value of an image region corresponding to the user gesture are different.

The at least one processor 111 may identify a predetermined user gesture based on the sensing data. Here, the predetermined user gesture may vary according to the user setting. For example, the predetermined user gesture may mean a gesture of pointing a specific direction with a finger, a gesture of moving both hands, a gesture of moving a finger in a clockwise direction or a counter-clockwise direction, etc.

The at least one processor 111 may store a plurality of user gestures in the memory 113. Then, the at least one processor 111 may specify a user gesture identified based on the sensing data among the plurality of user gestures. Then, the at least one processor 111 may change a luminance value of a projection image based on the identified user gesture.

According to one or more embodiments, the at least one processor 111 may change a luminance value of an image region corresponding to a user gesture.

According to one or more embodiments, the at least one processor 111 may change a luminance value of an image region corresponding to a user gaze based on a user gesture.

According to one or more embodiments, the at least one processor 111 may change a size of an image region corresponding to a user gaze based on a user gesture.

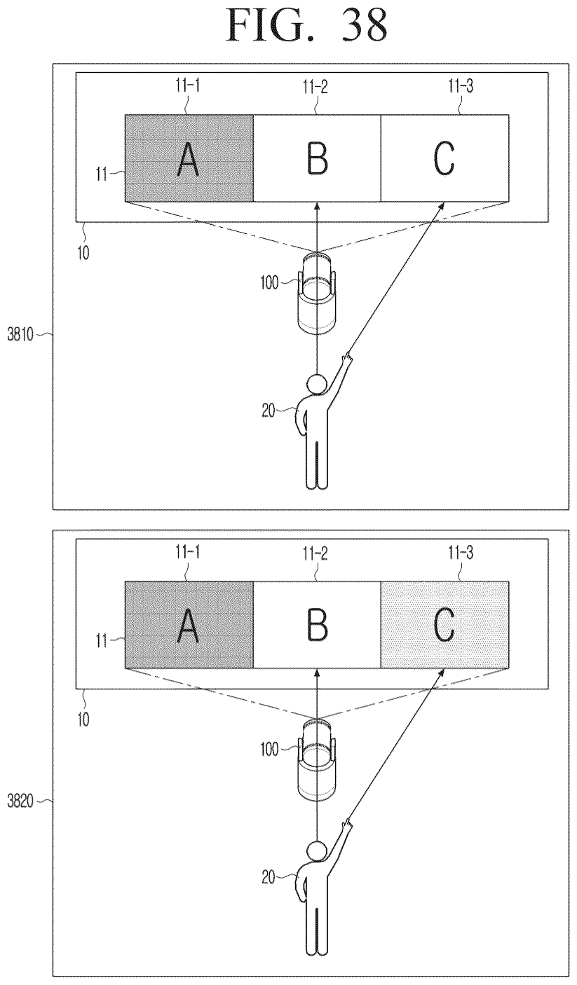

Detailed explanation in this regard will be described in FIG. 38 to FIG. 50.

Meanwhile, in the explanation below, it is illustrated that the projection surface 10 is a plane. According to one or more embodiments, the electronic device 100 may perform the same image correcting function even when the projection surface 10 is implemented as a curved surface.

Meanwhile, in the aforementioned explanation, it was described that a projection region is identified, but an operation of identifying a projection region may not necessarily be essential. The electronic device 100 may perform the image correcting function by comparing a user gaze and a projection direction of a projection image. For example, in case a direction of a user gaze and a projection direction coincide, the electronic device 100 may identify a region corresponding to the user gaze as a center region of the image. Also, the electronic device 100 may identify a region corresponding to a user gaze based on a difference in angles between the direction of the user gaze and a projection direction.

The electronic device 100 according to one or more embodiments may change the brightness of an image region based on the gaze of a user. In particular, as the electronic device 100 makes only a specific region corresponding to a user gaze relatively bright, the user's concentration can be improved. Also, in case a region not corresponding to a user gaze is changed to be relatively dark, power can be saved.

Meanwhile, the electronic device 100 may obtain distance information between the projection surface 10 and the user 20. The electronic device 100 may obtain sensing data through the distance sensor included in the sensor part 121. Then, the electronic device 100 may obtain distance information indicating a distance value between the projection surface 10 and the user 20 based on the sensing data. Here, the electronic device 100 may obtain a viewing angle of the user 20. The viewing angle of the user 20 may mean a predetermined angle (e.g., 120 degrees). The predetermined angle may be changed according to the setting. The electronic device 100 may divide a projection region in consideration of distance information between the projection surface 10 and the user 20, and the viewing angle of the user 20. The electronic device 100 may identify a region corresponding to the viewing angle of the user 20 in the entire projection region as the first projection region (or the main screen). The electronic device 100 may identify a region not corresponding to the viewing angle of the user 20 in the entire projection region as the second projection region (or the subsidiary screen).

Meanwhile, in the above, only simple components constituting the electronic device 100 were illustrated and explained, but in actual implementation, various components may additionally be included. Explanation in this regard will be described below with reference to FIG. 3.

FIG. 3 is a block diagram illustrating in detail a configuration of the electronic device 100 in FIG. 2.

Referring to FIG. 3, the electronic device 100 may include at least one of a processor 111, a projection part 112, memory 113, a communication interface 114, a manipulation interface 115, an input/output interface 116, a speaker 117, a microphone 118, a power part 119, a driver 120, or a sensor part 121.

Meanwhile, the components illustrated in FIG. 3 are merely various examples, and some components may be omitted, or new components may be added.

Meanwhile, contents that were already explained in FIG. 2 will be omitted.

The processor 111 may be implemented as a digital signal processor (DSP) processing digital signals, a microprocessor, and a time controller (TCON). However, the disclosure is not limited thereto, and the processor 111 may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machines (ARM) processor, or may be defined by the terms. Also, the processor 111 may be implemented as a system on chip (SoC) having a processing algorithm stored therein or large scale integration (LSI), or implemented in the form of a field programmable gate array (FPGA). In addition, the processor 111 may perform various functions by executing computer executable instructions stored in the memory 113.

The projection part 112 is a component that projects an image to the outside. The projection part 112 according to the one or more embodiments of the disclosure may be implemented in various projection types (e.g., a cathode-ray tube (CRT) type, a liquid crystal display (LCD) type, a digital light processing (DLP) type, a laser type, etc.). As an example, the CRT method has basically the same principle as a CRT monitor. In the CRT method, an image is enlarged to a lens in front of a cathode-ray tube (CRT), and the image is displayed on a screen. According to the number of cathode-ray tubes, the CRT method is divided into an one-tube method and a three-tube method, and in the case of the three-tube method, the method may be implemented while cathode-ray tubes of red, green, and blue colors are separated from one another.

As another example, the LCD method is a method of displaying an image by making a light output from a light source pass through a liquid crystal display. The LCD method is divided into a single-plate method and a three-plate method, and in the case of the three-plate method, a light output from a light source may be divided into red, green, and blue colors in a dichroic mirror (a mirror that reflects only lights of specific colors, and makes the rest pass through), and pass through a liquid crystal display, and then the lights may be gathered in one place.

As still another example, the DLP method is a method of displaying an image by using a digital micromirror device (DMD) chip. A projection part by the DLP method may include a light source, a color wheel, a DMD chip, a projection lens, etc. A light output from the light source may show a color as it passes through the rotating color wheel. The light that passed through the color wheel is input into the DMD chip. The DMD chip includes numerous micromirrors, and reflects the light input into the DMD chip. The projection lens may perform a role of enlarging the light reflected from the DMD chip to an image size.

As still another example, the laser method includes a diode pumped solid state (DPSS) laser and a galvanometer. As lasers outputting various colors, lasers wherein three DPSS lasers are installed for each of R, G, and B colors, and then their optical axes are overlapped by using a special mirror are used. The galvanometer includes a mirror and a motor of a high output, and moves the mirror at a fast speed. For example, the galvanometer may rotate the mirror at 40 KHz/sec at the maximum. The galvanometer is mounted according to a scanning direction, and in general, a projector performs plane scanning, and thus the galvanometer may also be arranged while being divided into x and y axes.

Meanwhile, the projection part 112 may include light sources of various types. For example, the projection part 112 may include at least one light source among a lamp, light emitting diodes (LEDs), and a laser.

The projection part 112 may output an image in a screen ratio of 4:3, a screen ratio of 5:4, and a wide screen ratio of 16:9 according to the use of the electronic device 100 or the user's setting, etc., and output an image in various resolutions such as WVGA (854*480), SVGA (800*600), XGA (1024*768), WXGA (1280*720), WXGA (1280*800), SXGA (1280*1024), UXGA (1600*1200), Full HD (1920*1080), etc. according to screen ratios.

Meanwhile, the projection part 112 may perform various functions for adjusting an output image by control by the processor 111. For example, the projection part 112 may perform functions such as zoom, keystone, quick corner (four corner) keystone, lens shift, etc.

Specifically, the projection part 112 may enlarge or reduce an image according to its distance (i.e., a projection distance) to the screen. That is, a zoom function may be performed according to the distance to the screen. Here, the zoom function may include a hardware method of adjusting a screen size by moving a lens, and a software method of adjusting the screen size by cropping an image, or the like. Meanwhile, when the zoom function is performed, it is necessary to adjust a focus of an image. For example, a method of adjusting a focus includes a manual focusing method, an electric focusing method, etc. The manual focusing method may mean a method of manually adjusting the focus, and the electric focusing method may mean a method in which a projector automatically adjusts the focus by using a built-in motor when the zoom function is performed. When performing the zoom function, the projection part 112 may provide a digital zoom function through software, and may provide an optical zoom function in which the zoom function is performed by moving the lens through the driver 120.

In addition, the projection part 112 may perform a keystone correction function. When a height does not match a front projection, the screen may be distorted up or down. The keystone correction function means a function of correcting a distorted screen. For example, if a distortion of an image occurs in a left-right direction of the screen, the screen may be corrected by using a horizontal keystone, and if a distortion of an image occurs in an up-down direction, the screen may be corrected by using a vertical keystone. The quick corner (four corner) keystone correction function is a function of correcting a screen in case the central area of the screen is normal but the corner areas are out of balance. The lens shift function is a function of moving a screen as it is in case the screen is outside a screen area.

Meanwhile, the projection part 112 may provide the zoom/keystone/focusing functions by automatically analyzing a surrounding environment and a projection environment without a user input. Specifically, the projection part 112 may automatically provide the zoom/keystone/focusing functions based on the distance between the electronic device 100 and the screen, information about a space where the electronic device 100 is currently positioned, information about an amount of ambient light, etc. detected through a sensor (e.g., a depth camera, a distance sensor, an infrared sensor, an illumination sensor, etc.).

Also, the projection part 112 may provide an illumination function by using a light source. In particular, the projection part 112 may provide the illumination function by outputting a light source by using LEDs. According to one or more embodiments, the projection part 112 may include one LED. According to another embodiment, the electronic device 100 may include a plurality of LEDs. Meanwhile, the projection part 112 may output a light source by using a surface emitting LED depending on implementation examples. Here, a surface emitting LED may mean an LED having a structure wherein an optical sheet is arranged on the upper side of the LED such that a light source is evenly dispersed and output. Specifically, if a light source is output through an LED, the light source may be evenly dispersed through an optical sheet, and the light source dispersed through the optical sheet may be incident on a display panel.

Meanwhile, the projection part 112 may provide a dimming function for adjusting the intensity of a light source to the user. Specifically, if a user input for adjusting the intensity of a light source is received from the user through the manipulation interface 115 (e.g., a touch display button or a dial), the projection part 112 may control the LED to output the intensity of the light source that corresponds to the received user input.

In addition, the projection part 112 may provide the dimming function based on a content analyzed by the processor 111 without a user input. In addition, the projection part 112 may control the LED to output the intensity of a light source based on information on a content that is currently provided (e.g., the content type, the content brightness, etc.).

Meanwhile, the projection part 112 may control a color temperature by control by the processor 111. Here, the processor 111 may control a color temperature based on a content. Specifically, if it is identified that a content is to be output, the processor 111 may obtain color information for each frame of the content of which output has been determined. Then, the processor 111 may control the color temperature based on the obtained color information for each frame. Here, the processor 111 may obtain at least one main color of the frame based on the color information for each frame. Then, the processor 111 may adjust the color temperature based on the obtained at least one main color. For example, the color temperature that the processor 111 may adjust may be divided into a warm type or a cold type. Here, it is assumed that a frame to be output (referred to as an output frame hereinafter) includes a scene wherein fire broke out. The processor 111 may identify (or obtain) that the main color is red based on the color information included in the current output frame. Then, the processor 111 may identify the color temperature corresponding to the identified main color (red). Here, the color temperature corresponding to the red color may be the warm type. Meanwhile, the processor 111 may use an artificial intelligence model to obtain the color information or the main color of a frame. According to one or more embodiments, the artificial intelligence model may be stored in the electronic device 100 (e.g., the memory 113). According to another embodiment, the artificial intelligence model may be stored in an external server that can communicate with the electronic device 100.

The memory 113 may be implemented as internal memory such as ROM (e.g., electrically erasable programmable read-only memory (EEPROM)), RAM, etc., included in the processor 111, or implemented as separate memory from the processor 111. In this case, the memory 113 may be implemented in the form of memory embedded in the electronic device 100, or implemented in the form of memory that can be attached to or detached from the electronic device 100 according to the use of stored data. For example, in the case of data for driving the electronic device 100, the data may be stored in memory embedded in the electronic device 100, and in the case of data for an extended function of the electronic device 100, the data may be stored in memory that can be attached to or detached from the electronic device 100.

Meanwhile, in the case of memory embedded in the electronic device 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can be attached to or detached from the electronic device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory that can be connected to a USB port (e.g., a USB memory), etc.

The memory 113 may store at least one instruction related to the electronic device 100. Also, the memory 113 may store an operating system (O/S) for driving the electronic device 100. In addition, the memory 113 may store various types of software programs or applications for the electronic device 100 to operate according to the one or more embodiments of the disclosure. Further, the memory 113 may include semiconductor memory such as flash memory, etc., or a magnetic storage medium such as a hard disk, etc.

Specifically, the memory 113 may store various types of software modules for the electronic device 100 to operate according to the one or more embodiments of the disclosure, and the processor 111 may control the operations of the electronic device 100 by executing the various types of software modules stored in the memory 113. That is, the memory 113 may be accessed by the processor 111, and reading/recording/correction/deletion/update, etc. of data by the processor 111 may be performed.

Meanwhile, in the disclosure, the term “memory 113” may be used as a meaning including a storage, ROM and RAM inside the processor 111, or a memory card (e.g., a micro SD card, a memory stick) mounted on the electronic device.

The communication interface 114 is a component that performs communication with various types of external devices according to various types of communication methods. The communication interface 114 may include a wireless communication module or a wired communication module. Here, each communication module may be implemented in a form of at least one hardware chip.

A wireless communication module may be a module that communicates with an external device wirelessly. For example, a wireless communication module may include at least one module among a Wi-Fi module, a Bluetooth module, an infrared communication module, or other communication modules.

A Wi-Fi module and a Bluetooth module may perform communication by a Wi-Fi method and a Bluetooth method, respectively. In the case of using a Wi-Fi module or a Bluetooth module, various types of connection information such as a service set identifier (SSID) and a session key, etc. is transmitted and received first, and connection of communication is performed by using the information, and various types of information can be transmitted and received thereafter.

An infrared communication module performs communication according to an infrared Data Association (IrDA) technology of transmitting data to a near field wirelessly by using infrared rays between visible rays and millimeter waves.

Other communication modules may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

A wired communication module may be a module that communicates with an external device via wire. For example, a wired communication module may include at least one of a local area network (LAN) module, an Ethernet module, a pair cable, a coaxial cable, an optical fiber cable, or an ultra wide-band (UWB) module.

The manipulation interface 115 may include various types of input devices. For example, the manipulation interface 115 may include physical buttons. Here, the physical buttons may include function keys, direction keys (e.g., four-direction keys), or dial buttons. According to one or more embodiments, the physical buttons may be implemented as a plurality of keys. According to another embodiment, the physical buttons may be implemented as one key. Here, in case the physical buttons are implemented as one key, the electronic device 100 may receive a user input by which the one key is pressed during a threshold time or longer. If a user input by which the one key is pressed during the threshold time or longer is received, the processor 111 may perform a function corresponding to the user input. For example, the processor 111 may provide the illumination function based on the user input.

Also, the manipulation interface 115 may receive a user input by using a non-contact method. In the case of receiving a user input through a contact method, a physical force should be transmitted to the electronic device 100. Accordingly, a method for controlling the electronic device 100 may be needed regardless of the physical force. Specifically, the manipulation interface 115 may receive a user gesture, and perform an operation corresponding to the received user gesture. Here, the manipulation interface 115 may receive the user gesture through a sensor (e.g., an image sensor or an infrared sensor).

In addition, the manipulation interface 115 may receive A user input by using a touch method. For example, the manipulation interface 115 may receive A user input through a touch sensor. According to one or more embodiments, the touch method may be implemented as the non-contact method. For example, the touch sensor may determine whether a user body approached within a threshold distance. Here, the touch sensor may identify a user input even when the user does not touch the touch sensor. Meanwhile, according to another implementation example, the touch sensor may identify a user input by which the user touches the touch sensor.

Meanwhile, the electronic device 100 may receive a user input in various ways other than the manipulation interface 115 described above. According to one or more embodiments, the electronic device 100 may receive a user input through an external remote control device. Here, the external remote control device may be a remote control device corresponding to the electronic device 100 (e.g., a control device dedicated to the electronic device 100) or a portable communication device (e.g., a smartphone or a wearable device) of the user. Here, the portable communication device of the user may store an application for controlling the electronic device 100. The portable communication device may obtain a user input through the application stored therein, and transmit the obtained user input to the electronic device 100. The electronic device 100 may receive the user input from the portable communication device, and perform an operation corresponding to the user's control command.

Meanwhile, the electronic device 100 may receive a user input by using voice recognition. According to one or more embodiments, the electronic device 100 may receive a user voice through the microphone included in the electronic device 100. According to another embodiment, the electronic device 100 may receive a user voice from the microphone or an external device. Specifically, the external device may obtain a user voice through the microphone of the external device, and transmit the obtained user voice to the electronic device 100. The user voice transmitted from the external device may be audio data or digital data converted from audio data (e.g., audio data converted into a frequency domain, etc.). Here, the electronic device 100 may perform an operation corresponding to the received user voice. Specifically, the electronic device 100 may receive audio data corresponding to the user voice through the microphone. The electronic device 100 may then convert the received audio data into digital data. The electronic device 100 may then convert the converted digital data into text data by using a speech-to-text (STT) function. According to one or more embodiments, the speech-to-text (STT) function may be directly performed in the electronic device 100.

According to another embodiment, the speech-to-text (STT) function may be performed in an external server. The electronic device 100 may transmit digital data to the external server. The external server may convert the digital data into text data, and obtain control command data based on the converted text data. The external server may transmit the control command data (which may here also include the text data) to the electronic device 100. The electronic device 100 may perform an operation corresponding to the user voice based on the obtained control command data.

Meanwhile, the electronic device 100 may provide a voice recognition function by using one assistance (or an artificial intelligence agent such as Bixby™, etc.), but this is merely one of various examples, and the electronic device 100 may provide the voice recognition function through a plurality of assistances. Here, the electronic device 100 may provide the voice recognition function by selecting one of the plurality of assistances based on a trigger word corresponding to the assistance or a specific key included in a remote controller.

Meanwhile, the electronic device 100 may receive a user input by using a screen interaction. A screen interaction may mean a function in which the electronic device 100 identifies whether a predetermined event is generated through an image projected on a screen (or a projection surface), and obtains a user input based on the predetermined event. Here, the predetermined event may be an event in which a predetermined object is identified in a specific position (e.g., a position on which a UI for receiving a user input is projected). Here, the predetermined object may include at least one of the user's body part (e.g., a finger), a pointer, or a laser point. If the predetermined object is identified in the position corresponding to the projected UI, the electronic device 100 may identify that a user input for selecting the projected UI was received. For example, the electronic device 100 may project a guide image such that a UI is displayed on the screen. The electronic device 100 may then identify whether the user selects the projected UI. Specifically, if the predetermined event is identified in the position of the projected UI, the electronic device 100 may identify that the user selected the projected UI. Here, the projected UI may include at least one item. Here, the electronic device 100 may perform spatial analysis to identify whether the predetermined event exists in the position of the projected UI. Here, the electronic device 100 may perform the spatial analysis through the sensor (e.g., an image sensor, an infrared sensor, a depth camera, a distance sensor, etc.). The electronic device 100 may identify whether the predetermined event is generated in the specific position (the position on which the UI is projected) by performing the spatial analysis. Then, if it is identified that the predetermined event is generated in the specific position (the position on which the UI is projected), the electronic device 100 may identify that a user input for selecting the UI corresponding to the specific position was received.

The input/output interface 116 is a component for inputting or outputting at least one of an audio signal or an image signal. The input/output interface 116 may receive at least one of an audio signal or an image signal from an external device, and output a control command to the external device.

Depending on implementation examples, the input/output interface 116 may be implemented as an interface inputting or outputting only audio signals and an interface inputting or outputting only image signals, or implemented as one interface inputting or outputting both audio signals and image signals.

Meanwhile, the input/output interface 116 according to one or more embodiments of the disclosure may be implemented as a wired input/output interface of at least one of a high definition multimedia interface (HDMI), a mobile high-definition link (MHL), a universal serial bus (USB), a USB C-type, a display port (DP), a Thunderbolt, a video graphics array (VGA) port, a red-green-blue (RGB) port, a D-subminiature (D-SUB) or a digital visual interface (DVI). According to one or more embodiments, the wired input/output interface may be implemented as an interface inputting or outputting only audio signals and an interface inputting or outputting only image signals, or implemented as one interface inputting or outputting both audio signals and image signals.

In addition, the electronic device 100 may receive data through the wired input/output interface, but this is merely one of various examples, and the electronic device 100 may receive power through the wired input/output interface. For example, the electronic device 100 may receive power from an external battery through a USB C-type, or receive power from an outlet through a power adapter. As another example, the electronic device 100 may receive power from an external device (e.g., a laptop computer or a monitor, etc.) through a display port (DP).

Meanwhile, the electronic device 100 may be implemented such that an audio signal is input through the wired input/output interface, and an image signal is input through a wireless input/output interface (or the communication interface). Alternatively, the electronic device 100 may be implemented such that an audio signal is input through a wireless input/output interface (or the communication interface), and an image signal is input through the wired input/output interface.

The speaker 117 is a component that outputs audio signals. In particular, the speaker 117 may include an audio output mixer, an audio signal processor, and an audio output module. The audio output mixer may mix a plurality of audio signals to be output as at least one audio signal. For example, the audio output mixer may mix an analog audio signal and another analog audio signal (e.g., an analog audio signal received from the outside) as at least one analog audio signal. The audio output module may include a speaker or an output terminal. According to one or more embodiments, the audio output module may include a plurality of speakers, and in this case, the audio output module may be disposed inside the main body, and audio emitted while covering at least a portion of a diaphragm of the audio output module may pass through a waveguide to be transmitted to the outside of the main body. The audio output module may include a plurality of audio output units, and the plurality of audio output units may be symmetrically disposed on the exterior of the main body, and accordingly, audio may be emitted to all directions, i.e., all directions in 360 degrees.

The microphone 118 is a component for receiving input of a user voice or other sounds, and converting them into audio data. The microphone 118 may receive a voice of a user in an activated state. For example, the microphone 118 may be formed as an integrated type on the upper side or the front surface direction, the side surface direction, etc. of the electronic device 100. The microphone 118 may include various components such as a microphone collecting a user voice in an analogue form, an amp circuit amplifying the collected user voice, an A/D conversion circuit that samples the amplified user voice and converts the user voice into a digital signal, a filter circuit that removes noise components from the converted digital signal, etc.

The power part 119 may receive power from the outside and supply power to the various components of the electronic device 100. The power part 119 according to the one or more embodiments of the disclosure may receive power in various ways. According to one or more embodiments, the power part 119 may receive power by using the connector 130 as illustrated in FIG. 1. In addition, the power part 119 may receive power by using a direct current (DC) power cord of 220V. However, the disclosure is not limited thereto, and the electronic device 100 may receive power by using a USB power cord, or may receive power by using a wireless charging method.

In addition, the power part 119 may receive power by using an internal battery or an external battery. The power part 119 according to the one or more embodiments of the disclosure may receive power through the internal battery. For example, the power part 119 may charge power of the internal battery by using at least one of a DC power cord of 220V, a USB power cord, or a USB C-Type power cord, and may receive power through the charged internal battery. Also, the power part 119 according to the one or more embodiments of the disclosure may receive power through the external battery. For example, the power part 119 may receive power through the external battery in case connection between the electronic device 100 and the external battery is performed through various wired communication methods such as the USB power code, the USB C-type power code, or a socket groove, etc. That is, the power part 119 may directly receive power from the external battery, or charge the internal battery through the external battery and receive power from the charged internal battery.

The power part 119 according to the disclosure may receive power by using at least one of the aforementioned plurality of power supply methods.

Meanwhile, with respect to power consumption, the electronic device 100 may have power consumption of a predetermined value (e.g., 43 W) or less due to the socket type, other standards, etc. Here, the electronic device 100 may vary power consumption to reduce the power consumption when using the battery. That is, the electronic device 100 may vary power consumption based on the power supply method, the power usage amount, or the like.

The driver 120 may drive at least one hardware component included in the electronic device 100. The driver 120 may generate physical force, and transmit the force to at least one hardware component included in the electronic device 100.

Here, the driver 120 may generate driving power for a moving operation of a hardware component included in the electronic device 100 (e.g., moving of the electronic device 100) or a rotating operation of a component (e.g., rotation of the projection lens).

The driver 120 may adjust a projection direction (or a projection angle) of the projection part 122. Also, the driver 120 may move the position of the electronic device 100. Here, the driver 120 may control the moving element 109 for moving the electronic device 100. For example, the driver 120 may control the moving element 109 by using the motor.

The sensor part 121 may include at least one sensor. Specifically, the sensor part 121 may include at least one of a tilt senor that senses the tilt of the electronic device 100 or an image sensor that captures an image. Here, the tilt sensor may be an acceleration sensor or a gyro sensor, and the image sensor may mean a camera or a depth camera. Meanwhile, the tilt sensor may also be described as a motion sensor. Also, the sensor part 121 may include various sensors other than a tilt sensor or an image sensor. For example, the sensor part 121 may include an illumination sensor or a distance sensor. The distance sensor may be a Time of Flight (ToF) sensor. Also, the sensor part 121 may include a LiDAR sensor.

Meanwhile, the electronic device 100 may control the illumination function by being interlocked with an external device. Specifically, the electronic device 100 may receive illumination information from an external device. Here, the illumination information may include at least one of brightness information or color temperature information set in the external device. Here, the external device may mean a device connected to the same network as the electronic device 100 (e.g., an IoT device included in the same home/company network) or a device that is not connected to the same network as the electronic device 100 but can communicate with the electronic device 100 (e.g., a remote control server). For example, it is assumed that an external illumination device (an IoT device) included in the same network as the electronic device 100 is outputting a red lighting at the brightness of 50. The external illumination device (an IoT device) may directly or indirectly transmit illumination information (e.g., information that the red lighting is being output at the brightness of 50) to the electronic device 100. Here, the electronic device 100 may control an output of a light source based on the illumination information received from the external illumination device. For example, if the illumination information received from the external illumination device includes information that the red lighting is being output at the brightness of 50, the electronic device 100 may output the red lighting at the brightness of 50.

Meanwhile, the electronic device 100 may control the illumination function based on biometric information. Specifically, the processor 111 may obtain the biometric information of the user. Here, the biometric information may include at least one of the body temperature, the heart rate, the blood pressure, the breathing, or the electrocardiogram of the user. Here, the biometric information may include various kinds of information other than the aforementioned information. As an example, the electronic device 100 may include a sensor for measuring biometric information. The processor 111 may obtain the biometric information of the user through the sensor, and control an output of a light source based on the obtained biometric information. As another example, the processor 111 may receive biometric information from an external device through the input/output interface 116. Here, the external device may mean a portable communication device (e.g., a smartphone or a wearable device) of the user. The processor 111 may obtain the biometric information of the user from the external device, and control an output of a light source based on the obtained biometric information. Meanwhile, depending on implementation examples, the electronic device 100 may identify whether the user is sleeping, and if it is identified that the user is sleeping (or is preparing to sleep), the processor 111 may control an output of a light source based on the biometric information of the user.

Meanwhile, the electronic device 100 according to the one or more embodiments of the disclosure may provide various smart functions.

Specifically, the electronic device 100 may be connected to a portable terminal device for controlling the electronic device 100, and the screen output from the electronic device 100 may be controlled through a user input that is input into the portable terminal device. For example, the portable terminal device may be implemented as a smartphone including a touch display, and the electronic device 100 may receive screen data provided by the portable terminal device from the portable terminal device and output the data, and the screen output from the electronic device 100 may be controlled according to a user input that is input into the portable terminal device.

The electronic device 100 may perform connection to the portable terminal device through various communication methods such as Miracast, Airplay, wireless Dalvik Executable (DEX) and a remote personal computer (PC) method, etc., and may share a content or music provided by the portable terminal device.

In addition, connection between the portable terminal device and the electronic device 100 may be performed by various connection methods. According to one or more embodiments, the portable terminal device may search for the electronic device 100 and perform wireless connection therebetween, or the electronic device 100 may search for the portable terminal device and perform wireless connection therebetween. The electronic device 100 may then output a content provided by the portable terminal device.

According to one or more embodiments, while a specific content or music is being output from the portable terminal device, if the portable terminal device is positioned around the electronic device 100 and then a predetermined gesture (e.g., a motion tap view) is detected through the display of the portable terminal device, the electronic device 100 may output the content or music that is being output from the portable terminal device.

According to one or more embodiments, while a specific content or music is being output from the portable terminal device, if the portable terminal device becomes close to the electronic device 100 by a predetermined distance or less (e.g., a non-contact tap view), or the portable terminal device touches the electronic device 100 twice at short intervals (e.g., a contact tap view), the electronic device 100 may output the content or music that is being output from the portable terminal device.

In the aforementioned embodiment, it was described that a screen identical to the screen that is being provided on the portable terminal device is provided on the electronic device 100, but the disclosure is not limited thereto. That is, if connection between the portable terminal device and the electronic device 100 is established, a first screen provided by the portable terminal device may be output on the portable terminal device, and a second screen provided by the portable terminal device, which is different from the first screen, may be output on the electronic device 100. As an example, the first screen may be a screen provided by a first application installed in the portable terminal device, and the second screen may be a screen provided by a second application installed in the portable terminal device. For example, the first screen and the second screen may be screens different from each other that are provided by one application installed in the portable terminal device. In addition, for example, the first screen may be a screen including a UI in a remote controller form for controlling the second screen.

The electronic device 100 according to the disclosure may output a standby screen. For example, the electronic device 100 may output a standby screen in case connection between the electronic device 100 and an external device was not performed or there was no input received from an external device during a predetermined time. A condition for the electronic device 100 to output a standby screen is not limited to the above-described example, and a standby screen may be output by various conditions.

The electronic device 100 may output a standby screen in the form of a blue screen, but the disclosure is not limited thereto. For example, the electronic device 100 may obtain an atypical object by extracting only the shape of a specific object from data received from an external device, and output a standby screen including the obtained atypical object. Meanwhile, the electronic device 100 may further include a display.

The display may be implemented as displays in various forms such as a liquid crystal display (LCD), an organic light emitting diodes (OLED) display, a plasma display panel (PDP), etc. Inside the display, driving circuits that may be implemented in forms such as an amorphous silicon thin film transistor (a-si TFT), a low temperature poly silicon (LTPS) TFT, an organic TFT (OTFT), etc., and a backlight unit, etc. may also be included. Meanwhile, the display may be implemented as a touch screen combined with a touch sensor, a flexible display, a three-dimensional (3D) display, etc. Also, the display according to the one or more embodiments of the disclosure may include not only a display panel outputting images, but also a bezel housing the display panel. In particular, a bezel according to the one or more embodiments of the disclosure may include a touch sensor for detecting user interactions.

Meanwhile, the electronic device 100 may further include a shutter part.

The shutter part may include at least one of a shutter, a fixing element, a rail, or a body.

Here, the shutter may block light output from the projection part 112. Here, the fixing element may fix the location of the shutter. Here, the rail may be a route through which the shutter and the fixing element are moved. Here, the body may be a component including the shutter and the fixing element.

FIG. 4 is a perspective view illustrating an exterior of the electronic device 100 according to one or more embodiments.

Referring to the embodiment 410 in FIG. 4, the electronic device 100 may include a support (or it is referred to as “a handle”) 108a.

The support 108a according to one or more embodiments may be a handle or a ring that is provided for the user to grip or move the electronic device 100. Alternatively, the support 108a may be a stand that supports the main body 105 while the main body 105 is laid sideways.

The support 108a may be connected in a hinge structure so as to be coupled to or separated from the outer circumferential surface of the main body 105, and may be selectively separated from or fixed to the outer circumferential surface of the main body 105 depending on the user's need. The number, shape, or disposition structure of the support 108a may be implemented in various ways without restriction. The support 108a may be built inside the main body 105, and taken out and used by the user depending on the user's need. Alternatively, the support 108a may be implemented as a separate accessory, and attached to or detached from the electronic device 100.

The support 108a may include a first support surface 108a-1 and a second support surface 108a-2. The first support surface 108a-1 may be a surface that faces the outward direction of the main body 105 while the support 108a is separated from the outer circumferential surface of the main body 105, and the second support surface 108a-2 may be a surface that faces the inward direction of the main body 105 while the support 108a is separated from the outer circumferential surface of the main body 105.

The first support surface 108a-1 may be developed from the lower portion to the upper portion of the main body 105 to be farther away from the main body 105, and the first support surface 108a-1 may have a flat or uniformly curved shape. The first support surface 108a-1 may support the main body 105 in case the electronic device 100 is held in such a manner that the outer side surface of the main body 105 is in contact with the bottom surface, i.e., in case the electronic device 100 is disposed in such a manner that the projection lens 101 is toward the front direction. In an embodiment in which the electronic device 100 includes two or more supports 108a, the head 103 and the projection angle of the projection lens 101 may be adjusted by adjusting the interval or hinge opening angle of the two supports 108a.

The second support surface 108a-2 may be a surface touched by the user or an external holding structure when the support 108a is supported by the user or an external holding structure, and may have a shape corresponding to a gripping structure of the user's hand or the external holding structure such that the electronic device 100 does not slip in case the electronic device 100 is supported or moved. The user may move the electronic device 100 by making the projection lens 101 face toward the front direction, and fixing the head 103 and holding the support 108a, and use the electronic device 100 like a flashlight.

The support groove 104 is a groove structure which is provided in the main body 105 and accommodates the support 108a when the support 108a is not used, and it may be implemented as a groove structure corresponding to the shape of the support 108a on the outer circumferential surface of the main body 105. Through the support groove 104, the support 108a may be stored on the outer circumferential surface of the main body 105 when the support 108a is not used, and the outer circumferential surface of the main body 105 may be maintained to be slick.

Alternatively, the support 108a may be a structure that is stored inside the main body 105, and is taken out to the outside of the main body 105 in case the support 108a is needed. In this case, the support groove 104 may be a structure that is led inside the main body 105 to accommodate the support 108a, and the second support surface 108a-2 may include a door that adheres to the outer circumferential surface of the main body 105 or opens or closes the separate support groove 104.

The electronic device 100 may include various kinds of accessories that are helpful in using or storing the electronic device 100. For example, the electronic device 100 may include a protection case for the electronic device 100 to be easily carried while being protected. Alternatively, the electronic device 100 may include a tripod that supports or fixes the main body 105, or a bracket that is coupled to the outer surface of the electronic device 100 and can fix the electronic device 100.

The embodiment 420 in FIG. 4 illustrates a state wherein the electronic device 100 in the embodiment 410 is held to be in contact with the bottom surface.

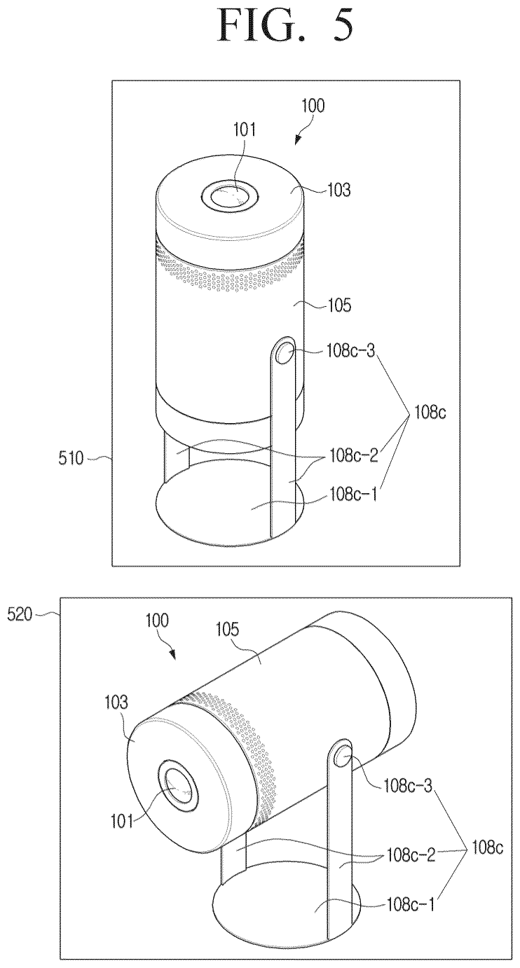

FIG. 5 is a perspective view illustrating an exterior of the electronic device 100 according to one or more embodiments.

Referring to the embodiment 510 in FIG. 5, the electronic device 100 may include a support (or it is referred to as “a stand”) 108b.

The support 108b according to one or more embodiments may be a handle or a ring that is provided for the user to grip or move the electronic device 100. Alternatively, the support 108b may be a stand that supports the main body 105 so as to be toward a certain angle while the main body 105 is laid sideways.

According to the one or more embodiments of the disclosure, the heights of the two support elements 108c-2 are identical, and each one cross-section of the two support elements 108c-2 may be coupled to or separated from a groove provided on one outer circumferential surface of the main body 105 by a hinge element 108c-3.

The two support elements may be hinge-coupled to the main body 105 on a predetermined point of the main body 105 (e.g., a 1/3-2/4 point of the height of the main body).

When the two support elements 108c-2 and the main body 105 are coupled by the hinge elements 108c-3, the main body 105 may rotate based on a virtual horizontal axis formed by the two hinge elements 108c-3, and accordingly, the projection angle of the projection lens 101 may be adjusted.

The embodiment 520 in FIG. 5 illustrates a state wherein the electronic device 100 in the embodiment 510 rotated.

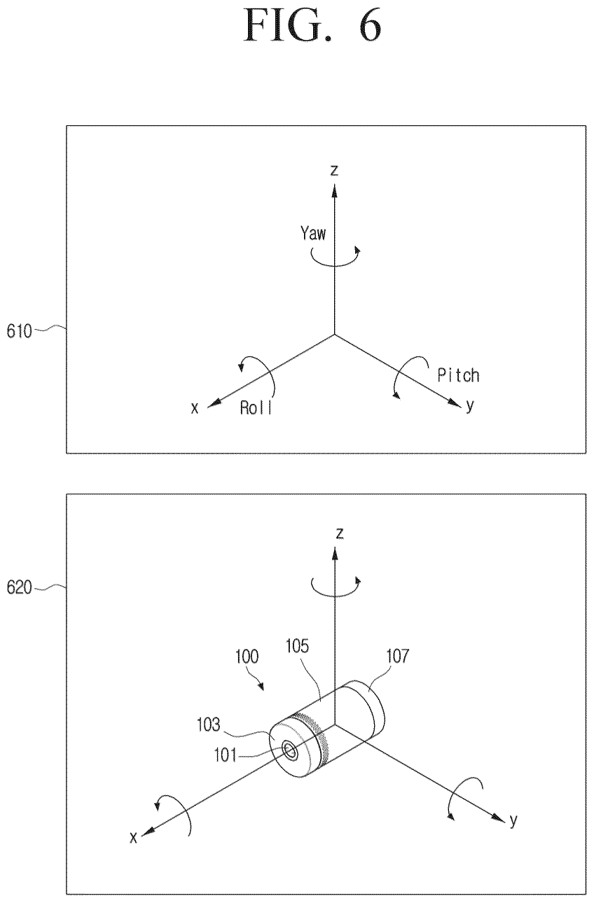

FIG. 6 is a diagram for illustrating rotation information of the electronic device 100.

The embodiment 610 in FIG. 6 is a graph that defined rotating directions according to the x, y, and z axes. Rotating based on the x axis may be defined as a roll, and rotating based on the y axis may be defined as a pitch, and rotating based on the z axis may be defined as a yaw.

The embodiment 620 in FIG. 6 may explain a rotating direction of the electronic device 100 as a rotating direction defined in the embodiment 610. The x axis rotation information of the electronic device 100 may correspond to a roll of rotating based on the x axis of the electronic device 100. The y axis rotation information of the electronic device 100 may correspond to a pitch of rotating based on the y axis of the electronic device 100. The z axis rotation information of the electronic device 100 may correspond to a yaw of rotating based on the z axis of the electronic device 100.

Meanwhile, the x axis rotation information may also be described as the first axis rotation information, the first axis tilt information, or horizontal warping information. In addition, the y axis rotation information may also be described as the second axis rotation information, the second axis tilt information, or vertical tilt information. Further, the z axis rotation information may also be described as the third axis rotation information, the third axis tilt information, or horizontal tilt information.

Meanwhile, the sensor part 121 may obtain state information (or tilt information) of the electronic device 100. Here, the state information of the electronic device 100 may mean a rotating state of the electronic device 100. Here, the sensor part 121 may include at least one of a gravity sensor, an acceleration sensor, or a gyro sensor. The x axis rotation information of the electronic device 100 and the y axis rotation information of the electronic device 100 may be determined based on sensing data obtained through the sensor part 121.

Meanwhile, the z axis rotation information may be obtained based on how much the electronic device 100 was rotated according to a movement of the electronic device 100.

According to one or more embodiments, the z axis rotation information may indicate how much the electronic device 100 was rotated to the z axis during a predetermined time. For example, the z axis rotation information may indicate how much the electronic device 100 was rotated to the z axis on a second time point based on a first time point.

According to one or more embodiments, the z axis rotation information may indicate an angle between a virtual xz plane from which the electronic device 100 views the projection surface 10 and a virtual plane perpendicular to the projection surface 10. For example, in case the projection surface 10 and the electronic device 100 view each other in a front direction, the z axis rotation information may be 0 degree.

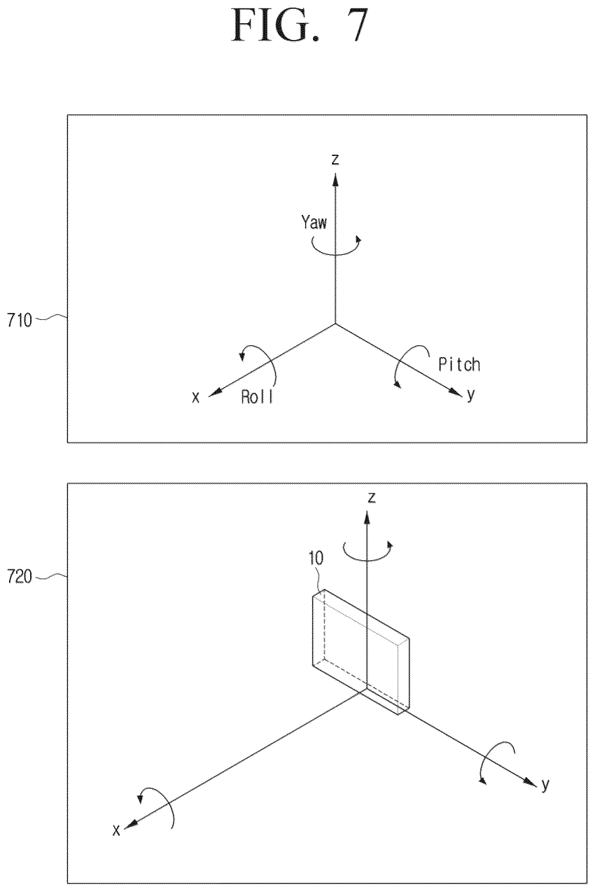

FIG. 7 is a diagram for illustrating rotation information of the projection surface 10.

The embodiment 710 in FIG. 7 is a graph that defined rotating directions according to the x, y, and z axes. Rotating based on the x axis may be defined as a roll, and rotating based on the y axis may be defined as a pitch, and rotating based on the z axis may be defined as a yaw.

The embodiment 720 in FIG. 7 may explain a rotating direction of the projection surface 10 as a rotating direction defined in the embodiment 710. The x axis rotation information of the projection surface 10 may correspond to a roll of rotating based on the x axis of the projection surface 10. The y axis rotation information of the projection surface 10 may correspond to a pitch of rotating based on the y axis of the projection surface 10. The z axis rotation information of the projection surface 10 may correspond to a yaw of rotating based on the z axis of the projection surface 10.

Meanwhile, the x axis rotation information may also be described as the first axis rotation information or the first axis tilt information. In addition, the y axis rotation information may also be described as the second axis rotation information or the second axis tilt information. Further, the z axis rotation information may also be described as the third axis rotation information or the third axis tilt information.

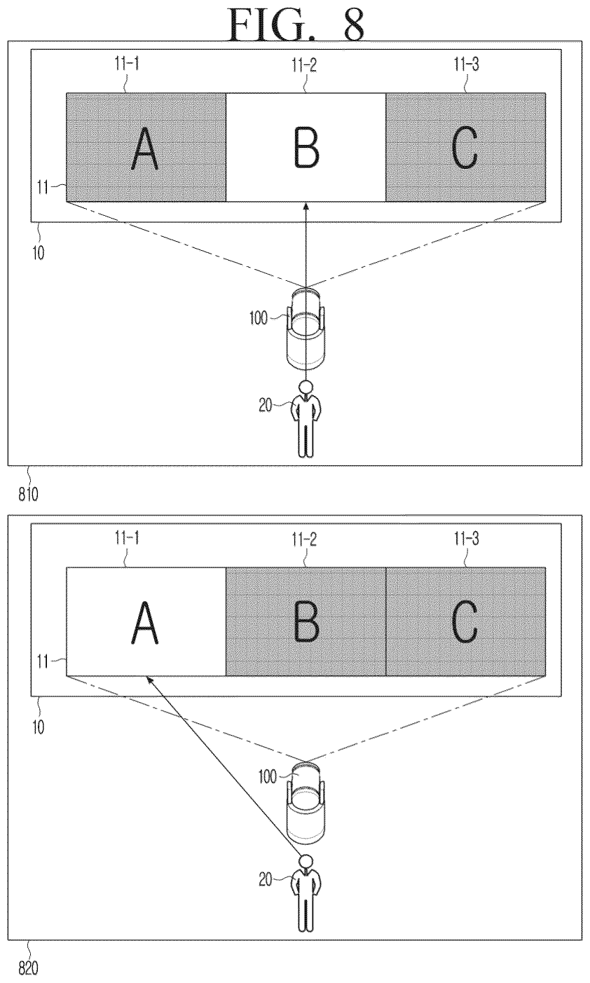

FIG. 8 is a diagram for illustrating an operation of projecting some regions of a projection image to be bright based on a user gaze.

Referring to FIG. 8, the electronic device 100 may identify the user 20. It is assumed that the user 20 is identified around the electronic device 100. The electronic device 100 may identify the user 20 through the sensor part 121. The electronic device 100 may identify a gaze of the user 20 (referred to as a user gaze hereinafter) based on sensing data obtained through the sensor part 121. The electronic device 100 may analyze a gaze direction based on the user gaze. Then, the electronic device 100 may identify an image region corresponding to the user gaze based on the gaze direction. Then, the electronic device 100 may divide the image region corresponding to the user gaze and an image region not corresponding to the user gaze, and project them in different luminance values.

The projection image 11 may include an image region 11-1, an image region 11-2, and an image region 11-3. Here, it is described that each region 11-1, 11-2, 11-3 is separated, but this is for indicating that the regions are divided, and in actuality, one image that is not divided may be projected on the projection surface 10.

Referring to the embodiment 810 in FIG. 8, it is assumed that the user 20 is viewing the image region 11-2. The electronic device 100 may project the image region 11-2 corresponding to the user gaze to be brighter than the image regions 11-1, 11-3 not corresponding to the user gaze.

For example, the electronic device 100 may maintain the basic luminance value (100%) of the image region 11-2, and lower the luminance values of the image region 11-1 and the image region 11-3 based on a threshold ratio (50%).

Referring to the embodiment 820 in FIG. 8, it is assumed that the user 20 is viewing the image region 11-1. The electronic device 100 may project the image region 11-1 corresponding to the user gaze to be brighter than the image regions 11-2, 11-3 not corresponding to the user gaze.

For example, the electronic device 100 may maintain the basic luminance value (100%) of the image region 11-1, and lower the luminance values of the image region 11-2 and the image region 11-3 based on the threshold ratio (50%).

Meanwhile, there are various methods for setting a luminance value of an image region to be bright or dark. According to one or more embodiments, a method of lowering a luminance value of a region not corresponding to a user gaze based on a luminance value of the original image by a threshold ratio will be described in FIG. 9. Also, according to one or more embodiments, a method of increasing a luminance value of a region corresponding to a user gaze based on a luminance value of the original image by a threshold ratio will be described in FIG. 10.

Meanwhile, in FIG. 8 and the drawings below, it is described that the projection surface 10 is a plane, but a projection region and an image region may be divided regardless of the curvature of the projection surface 10. Not only when the projection surface 10 is in a form of a plane as in FIG. 8 but also when the projection surface 10 is not a plane as in the embodiment 2210 and the embodiment 2220 in FIG. 22, the aforementioned operations and components may be applied in the same manner.

FIG. 9 is a diagram for illustrating an operation of making a luminance value of a region not corresponding to a user gaze small based on a luminance value of a projection image.

Referring to the embodiment 910 in FIG. 9, here, the projection image 11 may include an image region 11-1, an image region 11-2, and an image region 11-3. The projection image 11 may be projected based on a luminance value of the original image. It is described that the average luminance value of the projection image 11 in the embodiment 910 is maintained to be regular, but depending on implementation examples, luminance values of each of the regions included in the original image may be different. For the convenience of explanation, from below, it will be assumed that the luminance value of the original projection image 11 is identical for each region.

Referring to the embodiment 920 in FIG. 9, it is assumed that the user 20 views the position wherein the image region 11-2 is projected. The electronic device 100 may project the image region 11-2 to be brighter than the image region 11-1 and the image region 11-3. Specifically, the electronic device 100 may maintain the luminance value of the image region 11-2, and change the luminance values of the image region 11-1 and the image region 11-3 to luminance values smaller than the luminance value of the original image by a threshold ratio. For example, if the luminance value of the original image is 100%, the electronic device 100 may maintain the luminance value of the image region 11-2 as 100%, and lower the luminance values of the image region 11-1 and the image region 11-3 to 30%.

FIG. 10 is a diagram for illustrating an operation of making a luminance value of a region corresponding to a user gaze big based on a luminance value of a projection image.

Referring to the embodiment 1010 in FIG. 10, here, the projection image 11 may include an image region 11-1, an image region 11-2, and an image region 11-3. The projection image 11 may be projected based on a luminance value of the original image. It is described that the average luminance value of the projection image 11 in the embodiment 1010 is maintained to be regular, but depending on implementation examples, luminance values of each of the regions included in the original image may be different. For the convenience of explanation, from below, it will be assumed that the luminance value of the original projection image 11 is identical for each region.

Referring to the embodiment 1020 in FIG. 10, it is assumed that the user 20 views the position wherein the image region 11-2 is projected. The electronic device 100 may project the image region 11-2 to be brighter than the image region 11-1 and the image region 11-3. Specifically, the electronic device 100 may maintain the luminance values of the image region 11-1 and the image region 11-3, and change the luminance value of the image region 11-2 to a luminance value bigger than the luminance value of the original image by a threshold ratio. For example, if the luminance value of the original image is 100%, the electronic device 100 may maintain the luminance values of the image region 11-1 and the image region 11-3 as 100%, and heighten the luminance value of the image region 11-2 to 150%.

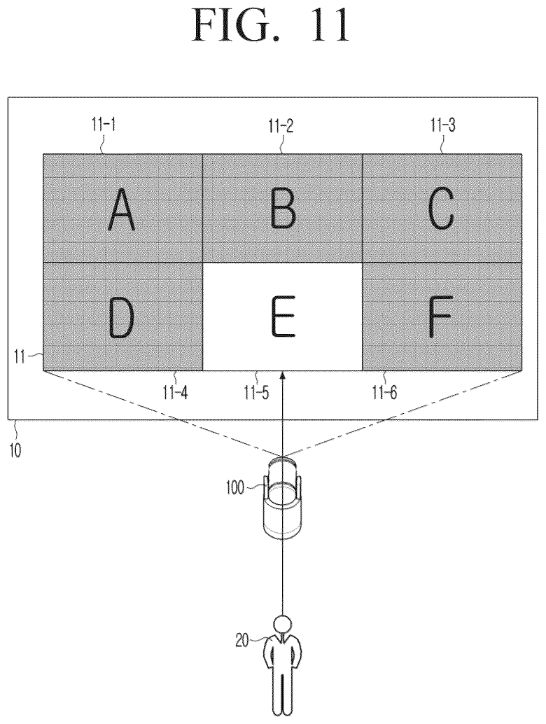

FIG. 11 is a diagram for illustrating movement of a region corresponding to a user gaze in an up-down direction.

Referring to FIG. 11, the projection image 11 may include a plurality of image regions 11-1, 11-2, 11-3, 11-4, 11-5, 11-6. It is assumed that the user 20 is viewing the image region 11-5. The electronic device 100 may project the image region 11-5 corresponding to the user gaze to be brighter than the remaining regions 11-1, 11-2, 11-3, 11-4, 11-6.

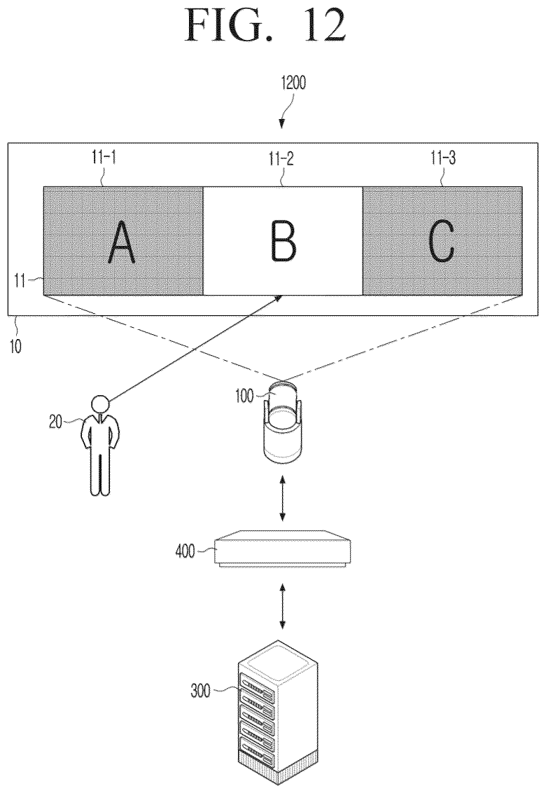

FIG. 12 is a diagram for illustrating the electronic device 100 communicating with a server 300.

Referring to FIG. 12, the system 1200 may include the electronic device 100 and a server 300. According to one or more embodiments, a router 400 connecting the electronic device 100 and the server 300 may exist. The electronic device 100 may obtain the position of the user 20 and the user gaze, and transmit them to the server 300. The server 300 may correct the projection image 11 based on the user gaze.

Specifically, the server 300 may perform the image correcting function such that the luminance value of the image region 11-2 corresponding to the user gaze is higher than the luminance values of the image regions 11-1, 11-3 not corresponding to the user gaze. Then, the server 300 may transmit the corrected projection image 11 to the electronic device 100.

According to one or more embodiments, the router 400 may exist for connecting communication between the electronic device 100 and the server 300. The electronic device 100 may transmit information related to a user gaze to the router 400, and the router 400 may then transmit the information related to the user gaze to the server 300. Further, the server 300 may transmit the corrected projection image 11 to the router 400, and the router 400 may transmit the corrected projection image 11 to the electronic device 100. Then, the electronic device 100 may project the corrected projection image 11.

FIG. 13 is a diagram for illustrating the electronic device 100 communicating with a terminal device 500.

Referring to FIG. 13, the system 1300 may include the electronic device 100 and a terminal device 500. The electronic device 100 and the terminal device 500 may perform communication with each other. Here, the terminal device 500 may mean a device corresponding to the user. For example, the terminal device 500 may mean augmented reality (AR) glasses 501, a neck band device 502, a smartphone 503, etc.

Here, the terminal device 500 may obtain information indicating the position of the user 20 and a gaze of the user 20. Then, the terminal device 500 may transmit the information indicating the position of the user 20 and the gaze of the user 20 to the electronic device 100. The electronic device 100 may obtain the user gaze (or the direction of the user gaze) based on the information received from the terminal device 500. Then, the electronic device 100 may project the image region 11-2 corresponding to the user gaze to be brighter than the image regions 11-1, 11-3 not corresponding to the user gaze.

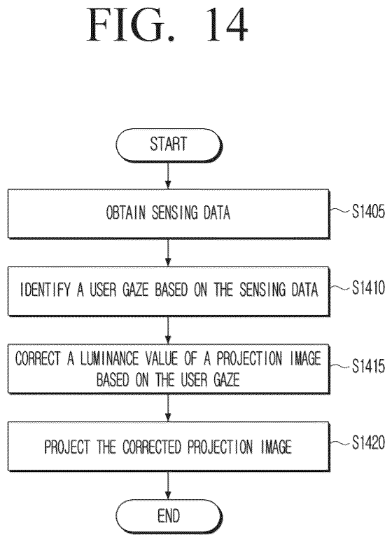

FIG. 14 is a flow chart for illustrating an operation of correcting a luminance value of a projection image based on a user gaze.

Referring to FIG. 14, the electronic device 100 may obtain sensing data in operation S1405. Here, the sensing data may mean data that was obtained through at least one sensor included in the sensor part 121.

Then, the electronic device 100 may identify a user gaze based on the sensing data in operation S1410. Here, the user gaze may indicate in which direction the user 20 is viewing. Accordingly, the user gaze may be described as the gaze direction of the user or the gaze region of the user, etc.

Then, the electronic device 100 may correct a luminance value of a projection image based on the user gaze in operation S1415. The electronic device 100 may correct the projection image itself such that some regions corresponding to the user gaze are projected to be brighter than the remaining region not corresponding to the user gaze.

Then, the electronic device 100 may output the corrected projection image in operation S1420.

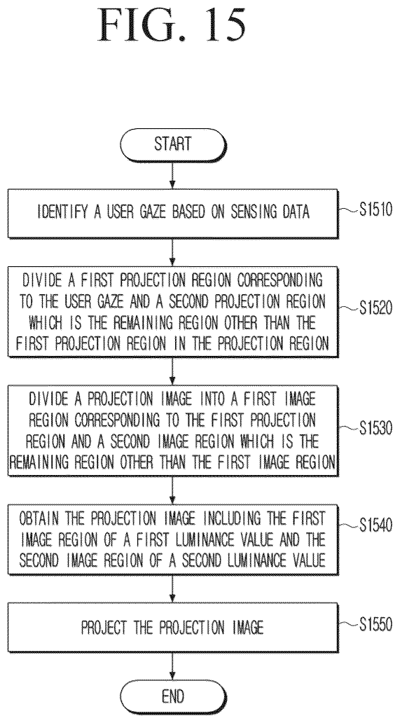

FIG. 15 is a flow chart for illustrating in detail the operation in FIG. 14.

Referring to FIG. 15, the electronic device 100 may identify a user gaze based on sensing data in operation S1510. The electronic device 100 may divide a projection region into a first projection region corresponding to the user gaze and a second projection region which is the remaining region other than the first projection region in operation S1520. Here, the projection region may mean a region wherein the projection image 11 is projected in the entire region of the projection surface 10. Here, the second projection region may mean a region not corresponding to the user gaze.

Then, the electronic device 100 may divide a first image region corresponding to the first projection region and a second image region which is the remaining region other than the first image region in the projection image.

The electronic device 100 may separately divide the projection region and the image region. The projection region may mean a space in reality or a virtual region wherein the projection image is projected. The image region may mean all or some of the regions included in the projection image. Also, the projection region may mean a region wherein the image region is projected.

Then, the electronic device 100 may obtain the projection image including the first image region of a first luminance value and the second image region of a second luminance value in operation S1540. In other words, the electronic device 100 may modify the projection image to comprise the first image region of the first luminance value and the second image region of the second luminance value. Here, the electronic device 100 may perform the image correcting operation for projecting the first image region in the first luminance value and projecting the second image region in the second luminance value. Specifically, the electronic device 100 may change the luminance value of at least one region from among the first image region or the second image region of the projection image.

Then, the electronic device 100 may project the projection image in operation S1550.

FIG. 16 is a flow chart for illustrating an operation of changing a user gaze.

The operations S1610, S1620, S1630, S1640, and S1650 in FIG. 16 may correspond to the operations S1510, S1520, S1530, S1540, and S1550 in FIG. 15. Accordingly, overlapping explanation will be omitted.

After projecting the projection image, the electronic device 100 may reidentify the user gaze based on the sensing data in operation S1660. The electronic device 100 may obtain new sensing data that is different from the sensing data obtained in the operation S1610. Then, the electronic device 100 may identify a user gaze based on the new sensing data.

The electronic device 100 may identify whether the user gaze was changed in operation S1670. If the user gaze is changed in operation S1670-Y, the electronic device 100 may repeat the operations S1620 to S1650. Specifically, the electronic device 100 may perform an operation of dividing the projection region and an operation of dividing the image region according to the changed user gaze.

If the user gaze is not changed in operation S1670-N, the electronic device 100 may determine whether the projection image ends in operation S1680. Ending of the projection image may be determined based on a command of the user for not projecting the projection image anymore. If the projection image does not end in operation S1680-N, the electronic device 100 may repeat the operations S1650 to S1680. If the projection image ends in operation S1680-Y, the electronic device 100 may not project the projection image anymore.

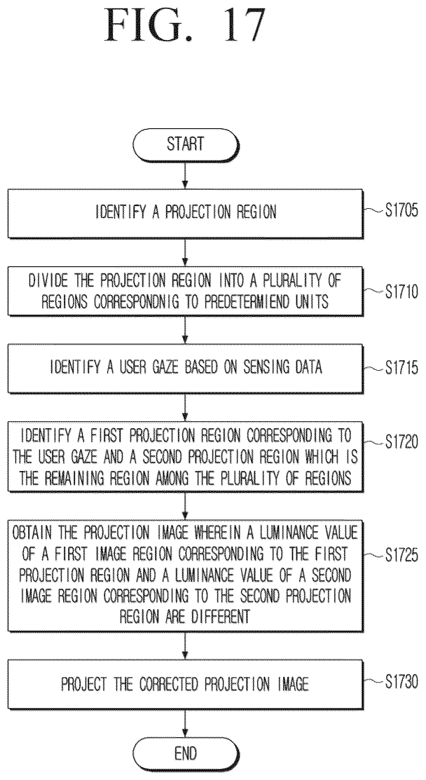

FIG. 17 is a flow chart for illustrating an operation of obtaining projection images of which luminance values are different based on a user gaze.

Referring to FIG. 17, the electronic device 100 may identify a projection region in operation S1705. The electronic device 100 may divide the projection region into a plurality of regions corresponding to a plurality of predetermined units in operation S1710. The electronic device 100 may obtain sensing data.

The electronic device 100 may identify a user gaze based on the sensing data in operation S1715. The electronic device 100 may identify a first projection region corresponding to the user gaze and a second projection region which is the remaining region other than the first projection region among the plurality of divided regions in operation S1720.

The electronic device 100 may obtain the projection image wherein a luminance value of a first image region corresponding to the first projection region and a luminance value of a second image region corresponding to the second projection region are different in operation S1725. Here, the electronic device 100 may change luminance values for some of the image regions by performing an image correcting function.

Then, the electronic device 100 may project the obtained (or corrected) projection image in operation S1730.

FIG. 18 is a diagram for illustrating an operation of dividing a projection region based on a position of a user gaze and a predetermined distance.

Referring to FIG. 18, the electronic device 100 may identify an entire projection region 1810 wherein a projection image is projected in the entire region of the projection surface 10. Here, the electronic device 100 may divide (or partition) the projection region 1810 based on a user gaze. The electronic device 100 may identify a position p0 corresponding to the user gaze in the projection region 1810. The electronic device 100 may identify a projection region 1810-2 that was extended from the identified position p0 by a threshold distance x1/2. The identified projection region 1810-2 may be described as a projection region corresponding to the user gaze. Also, the horizontal length x1 of the identified projection region 1810-2 may be two times of the threshold distance x1/2. The electronic device 100 may divide the entire projection region 1810 into the projection region 1810-2 corresponding to the user gaze and projection regions 1810-1, 1810-3 not corresponding to the user gaze.

In FIG. 18, it was described that a projection region is divided, but the same operation may be applied to an operation of dividing an image region.

FIG. 19 is a flow chart for illustrating an operation of dividing a projection region based on a position of a user gaze and a predetermined distance.

The operations S1910, S1930, S1940, and S1950 in FIG. 19 may correspond to the operations S1510, S1530, S1540, and S1550 in FIG. 15. Accordingly, overlapping explanation will be omitted.

After a user gaze is identified, the electronic device 100 may identify an entire projection region in operation S1921. The electronic device 100 may identify a first projection region corresponding to the user gaze based on a position corresponding to the user gaze and a predetermined distance in operation S1922. The electronic device 100 may identify a second projection region which is the remaining region other than the first projection region in the entire projection region in operation S1923.

Afterwards, the electronic device 100 may perform the operations S1930 to S1950.

FIG. 20 is a diagram for illustrating an operation of dividing a projection region into groups of a predetermined number.

Referring to FIG. 20, the electronic device 100 may identify an entire projection region 2010 wherein a projection image is projected in the entire region of the projection surface 10. Here, the electronic device 100 may divide (or partition) the projection region 2010 based on a user gaze. The electronic device 100 may identify a position p0 corresponding to the user gaze in the projection region 2010.

The electronic device 100 may divide a projection region by a predetermined number (e.g., three). Here, the horizontal lengths of the divided projection regions (e.g., 3/d) may be identical. The horizontal length of the entire projection region may be d. The electronic device 100 may divide the entire projection region into a plurality of projection regions 2010-1, 2010-2, 2010-3.

The electronic device 100 may identify a specific region 2010-2 based on the user gaze among the plurality of projection regions 2010-1, 2010-2, 2010-3. The identified projection region 2010-2 may be described as a projection region corresponding to the user gaze. The electronic device 100 may divide the entire projection region 2010 into the projection region 2010-2 corresponding to the user gaze and projection regions 2010-1, 2010-3 not corresponding to the user gaze.

In FIG. 20, it was described that a projection region is divided, but the same operation may be applied to an operation of dividing an image region.

FIG. 21 is a flow chart for illustrating an operation of dividing a projection region into groups of a predetermined number.

The operations S2110, S2130, S2140, and S2150 in FIG. 21 may correspond to the operations S1510, S1530, S1540, and S1550 in FIG. 15. Accordingly, overlapping explanation will be omitted.

After a user gaze is identified, the electronic device 100 may identify a projection region in operation S2121. The electronic device 100 may divide the projection region into groups of a predetermined number in operation S2122. Here, the horizontal lengths of the groups of the predetermined number may be identical.

The electronic device 100 may divide the groups of the predetermined number into a first projection region corresponding to a user gaze and a second projection region which is the remaining region other than the first projection region in operation S2123.

Afterwards, the electronic device 100 may perform the operations S2130 to S2150.

FIG. 22 is a diagram for illustrating an operation of dividing a projection region based on boundary lines.

Referring to the embodiment 2210 in FIG. 22, the electronic device 100 may identify an entire projection region 2611 wherein a projection image is projected in the entire region of the projection surface 10. Here, the electronic device 100 may divide (or partition) the projection region 2611 based on boundary lines 10-1, 10-2 of the projection surface 10. The electronic device 100 may identify a position p0 corresponding to a user gaze in the projection region 2611.

The electronic device 100 may divide the entire projection region 2611 into at least one projection region 2611-1, 2611-2, 2611-3 based on the boundaries 10-1, 10-2 of the projection surface 10.

The electronic device 100 may identify a specific region 2611-2 based on the user gaze among the plurality of projection regions 2611-1, 2611-2, 2611-3. The identified projection region 2611-2 may be described as a projection region corresponding to the user gaze. The electronic device 100 may divide the entire projection region 2611 into the projection region 2611-2 corresponding to the user gaze and projection regions 2611-1, 2611-3 not corresponding to the user gaze.

Referring to the embodiment 2220 in FIG. 22, the projection surface 10 may be a curved surface. In case the projection surface 10 is a curved surface, the electronic device 100 may divide the entire projection region 2621 into at least one projection region 2621-1, 2621-2, 2621-3 based on the boundary lines 10-1, 10-2 of the projection surface 10.

Meanwhile, in the embodiment 2220, there may be a situation wherein the boundary lines 10-1, 10-2 are not identified. In case boundary lines are not identified on the projection surface 10 in a form of a curved surface, the electronic device 100 may divide the projection region based on a viewing angle of the user or a predetermined distance, etc.

The form of the projection surface 10 may be various forms such as a plane, a curved surface, etc. The electronic device 100 may divide the projection region regardless of the form of the projection surface 10.

FIG. 23 is a flow chart for illustrating an operation of dividing a projection region based on boundary lines.

The operations S2310, S2330, S2340, and S2350 in FIG. 23 may correspond to the operations S1510, S1530, S1540, and S1550 in FIG. 15. Accordingly, overlapping explanation will be omitted.

After a user gaze is identified, the electronic device 100 may identify a projection region and boundary lines of the projection surface 10 in operation S2321. The electronic device 100 may divide the entire projection region into a plurality of groups based on the projection region and the boundary lines of the projection surface in operation S2322. Here, the plurality of groups may mean regions divided based on the boundary lines of the projection surface. The electronic device 100 may divide the plurality of groups into a first projection region corresponding to the user gaze and a second projection region which is the remaining region other than the first projection region.

Afterwards, the electronic device 100 may perform the operations S2330 to S2350.

Meanwhile, the electronic device 100 may perform an operation of performing a luminance value changing function by using power information. The electronic device 100 may obtain power information. Here, the power information may include a remaining power value of a battery included in the electronic device 100. The electronic device 100 may identify whether the remaining power value is smaller than or equal to a threshold value based on the power information. If the remaining power value is smaller than or equal to the threshold value, the electronic device 100 may determine that power is insufficient, and perform an operation for saving the power.

The electronic device 100 may save power through an operation of lowering luminance values for some regions of a projection image. In case the luminance values of the image region 11-1 and the image region 11-3 are lowered as in the embodiment 920 in FIG. 9, the power of the electronic device 100 can be saved.

If the remaining power value is smaller than or equal to the threshold value, the electronic device 100 may operate in a power saving mode. Specifically, the electronic device 100 may perform the operations in FIG. 15.

If the remaining power value is not smaller than or equal to the threshold value, the electronic device 100 may operate in a general mode. Specifically, the electronic device 100 may project the projection image without a luminance value changing operation.

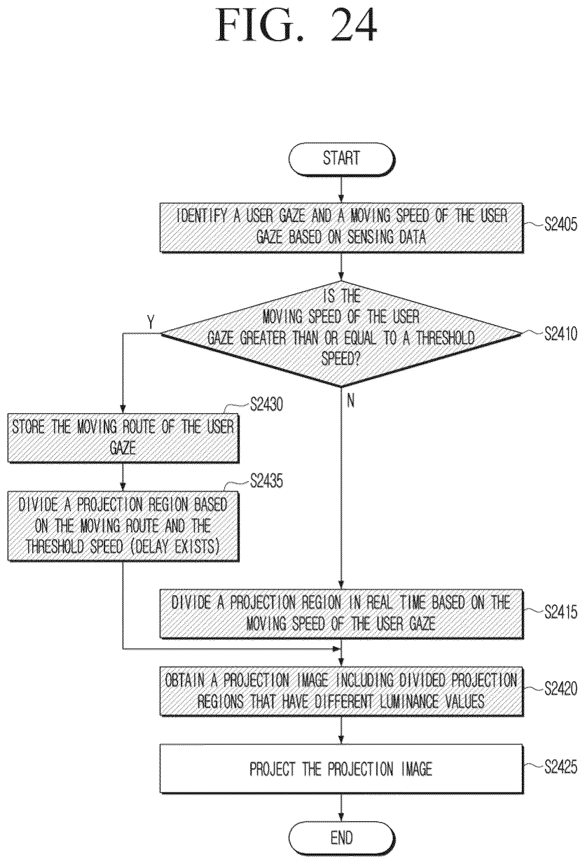

FIG. 24 is a flow chart for illustrating an operation of dividing a projection region based on a moving speed of a user gaze.

Referring to FIG. 24, the electronic device 100 may identify a user gaze and a moving speed of the user gaze based on sensing data in operation S2405. The electronic device 100 may identify whether the moving speed of the user gaze is greater than or equal to a threshold speed in operation S2410.

If the moving speed of the user gaze is not greater than or equal to the threshold speed in operation S2410-N, the electronic device 100 may divide a projection region in real time based on the moving speed of the user gaze in operation S2415. Specifically, the electronic device 100 may identify a projection region corresponding to the user gaze in the entire projection region. Then, the electronic device 100 may obtain a projection image including divided projection regions that have different luminance values in operation S2420. Then, the electronic device 100 may project the projection image.

If the moving speed of the user gaze is greater than or equal to the threshold speed in operation S2410-Y, the electronic device 100 may store the moving route of the user gaze in operation S2430. The electronic device 100 may divide the projection region based on the moving route and the threshold speed in operation S2435. Afterwards, the electronic device 100 may perform the operations S2420 to S2425.

In case a user gaze moves too fast, the electronic device 100 may not perform an image correcting operation in response to the moving speed of the user gaze. In such a case, the user may feel a phenomenon of discontinuity. Accordingly, in case a user gaze moves too fast (in case a user gaze is greater than or equal to the threshold speed), the electronic device 100 may store the moving route of the user gaze in the memory 112, and perform the image correcting operation based on the regular threshold speed (or limit speed).

FIG. 25 is a diagram for illustrating an operation of identifying whether a user gaze is beyond a projection region.

Referring to the embodiment 2510 in FIG. 25, it is assumed that a user gaze is beyond a region wherein a projection image 11 is displayed (or a projection region) 2511. The electronic device 100 may identify whether the user gaze is beyond the region 2511 wherein the projection image 11 is displayed by analyzing the user gaze. The electronic device 100 may perform a function of displaying an image region corresponding to the user gaze to be bright. In the embodiment 2510, the region wherein the user gaze stayed to the last may be the region wherein the image region 11-1 is displayed. Accordingly, the image region 11-1 may be projected to be brighter than the image region 11-2 and the image region 11-3.

Referring to the embodiment 2520 in FIG. 25, if a user gaze is beyond a region wherein a projection image 11 is displayed (or a projection region), the electronic device 100 may change the position of the projection region 2511. The changed position of the projection region 2521 may be changed according to the moving direction of the user gaze. In case the user gaze is beyond the previous projection region 2511, the projection position of the projection image 11 keeps changing according to the user gaze, and thus the user can easily change the position wherein the projection image 11 is projected.

FIG. 26 is a flow chart for illustrating an operation of identifying whether a user gaze is beyond a projection region.

The operations S2610, S2620, S2630, S2640, and S2650 in FIG. 26 may correspond to the operations S1510, S1520, S1530, S1540, and S1550 in FIG. 15. Accordingly, overlapping explanation will be omitted.

After a user gaze is identified, the electronic device 100 may identify a projection region in operation S2615. Then, the electronic device 100 may identify whether the user gaze is beyond the projection region in operation S2616.

In case the user gaze is beyond the projection region in operation S2616-Y, the electronic device 100 may change the projection direction based on the user gaze in operation S3317. Here, changing the projection direction may mean changing the position of the projection region wherein a projection image is projected. Then, the electronic device 100 may reidentify the projection region based on the changed projection direction in operation S2618. Then, the electronic device 100 may perform the operations S2620 to S2650.

In case the user gaze is not beyond the projection region in operation S2616-N, the electronic device 100 may perform the operations S2620 to S2650.

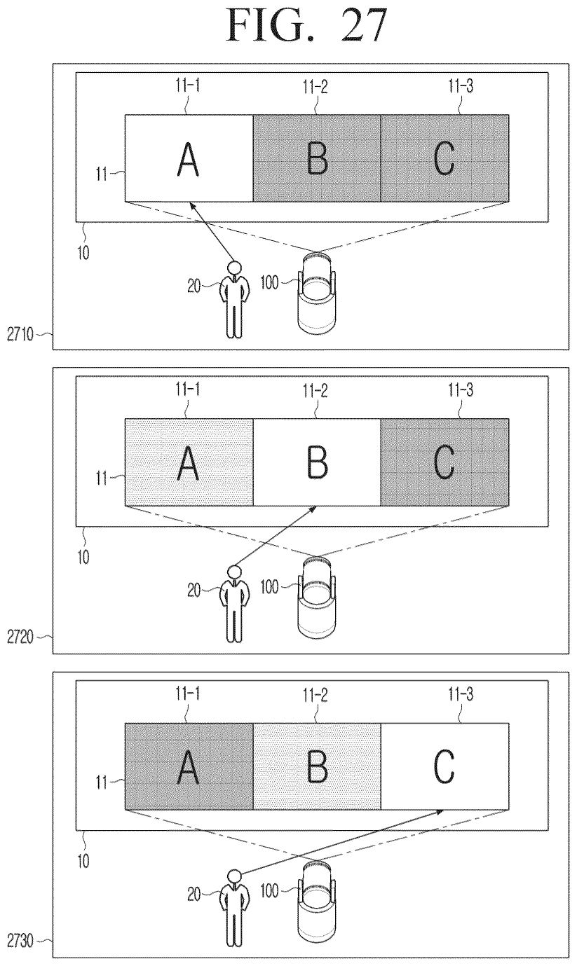

FIG. 27 is a diagram for illustrating an operation of changing a luminance value according to movement of a user gaze.

Referring to the embodiment 2710 in FIG. 27, it is assumed that the user 20 views the image region 11-1. The electronic device 100 may project the image region 11-1 to be brighter than the image region 11-2 and the image region 11-3. For example, the electronic device 100 may maintain the basic luminance value (100%) of the image region 11-1, and lower the luminance values of the image region 11-2 and the image region 11-3 based on a threshold ratio (50%).

Referring to the embodiment 2720 in FIG. 27, it is assumed that the user 20 views the image region 11-2. The electronic device 100 may project the image region 11-2 to be brighter than the image region 11-1 and the image region 11-3. Here, the image region 11-1 may be a region that the user 20 viewed on a previous time point. Accordingly, the electronic device 100 may project the image region 11-1 to be brighter than the image region 11-3, and project the image region 11-1 to be darker than the image region 11-2. For example, the electronic device 100 may maintain the basic luminance value (100%) of the image region 11-2 and lower the luminance value of the image region 11-1 based on a first threshold ratio (80%), and lower the luminance value of the image region 11-3 based on a second threshold ratio (50%). The first threshold ratio may be bigger than the second threshold ratio.

Referring to the embodiment 2730 in FIG. 27, it is assumed that the user 20 views the image region 11-3. The electronic device 100 may project the image region 11-3 to be brighter than the image region 11-1 and the image region 11-2. Here, the image region 11-2 may be a region that the user 20 viewed on a previous time point. Accordingly, the electronic device 100 may project the image region 11-2 to be brighter than the image region 11-1, and project the image region 11-2 to be darker than the image region 11-3.

For example, the electronic device 100 may maintain the basic luminance value (100%) of the image region 11-3 and lower the luminance value of the image region 11-2 based on the first threshold ratio (80%), and lower the luminance value of the image region 11-1 based on the second threshold ratio (50%). The first threshold ratio may be bigger than the second threshold ratio.

FIG. 28 is a diagram for illustrating an operation of changing a luminance value according to a plurality of user gazes.

Referring to FIG. 28, the electronic device 100 may identify a plurality of users 20-1, 20-2. Here, the electronic device 100 may respectively identify a user gaze of the first user 20-1 and a user gaze of the second user 20-2. It is assumed that the user gaze of the first user 20-1 was identified earlier than the user gaze of the second user 20-2. In other words, luminance values of the first region (of the first user gaze) and second region (of the second user gaze) may be higher than a luminance value of a remaining region.

The electronic device 100 may project the image region 11-2 corresponding to the user gaze of the first user 20-1 to be brighter than the image region 11-1 and the image region 11-3.

Also, the electronic device 100 may project the image region 11-3 corresponding to the user gaze of the second user 20-2 to be brighter than the image region 11-1, and to be darker than the image region 11-2.

For example, the electronic device 100 may maintain the basic luminance value (100%) of the image region 11-2 and lower the luminance value of the image region 11-3 based on the first threshold ratio (80%), and lower the luminance value of the image region 11-1 based on the second threshold ratio (50%). The first threshold ratio may be bigger than the second threshold ratio.

FIG. 29 is a flow chart for illustrating an operation of changing a luminance value according to a plurality of user gazes.

The electronic device 100 may identify a first user gaze (a gaze of a first user) and a second user gaze (a gaze of a second user) based on sensing data in operation S2910.

Here, the electronic device 100 may identify a first projection region corresponding to the first user gaze in the projection region in operation S2921. The electronic device 100 may identify a second projection region corresponding to the second user gaze in the projection region in operation S2922. The electronic device 100 may identify a third projection region which is the remaining region other than the first projection region and the second projection region in the projection region in operation S2923.

Here, the electronic device 100 may identify a first luminance value of a first image region corresponding to the first projection region in operation S2931. The electronic device 100 may identify a second luminance value of a second image region corresponding to the second projection region in operation S2932. The electronic device 100 may identify a third luminance value of a third image region corresponding to the third projection region in operation S2933.

Here, the electronic device 100 may obtain a projection image including the first image region of the first luminance value, the second image region of the second luminance value, and the third image region of the third luminance value in operation S2940. Then, the electronic device 100 may project the projection image.

According to one or more embodiments, the first luminance value may be higher than the second luminance value and the third luminance value, and the second luminance value and the third luminance value may be identical.

According to one or more embodiments, the first luminance value may be higher than the second luminance value and the third luminance value, and the second luminance value may be higher than the third luminance value.

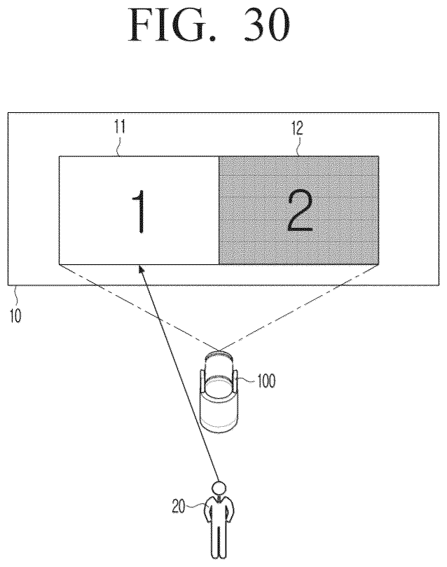

FIG. 30 is a diagram for illustrating an operation of changing luminance values of some contents as a multi-view function is performed.

Referring to FIG. 30, the electronic device 100 may perform a multi-view function of projecting a first content 11 and a second content 12. It is assumed that the user 20 views a projection region wherein the first content 11 is displayed. The electronic device 100 may project the first content 11 to be brighter than the second content 12. For example, the electronic device 100 may project the first content 11 by maintaining the basic luminance value (100%), and project the second content 12 by lowering the luminance value based on the threshold ratio (50%).

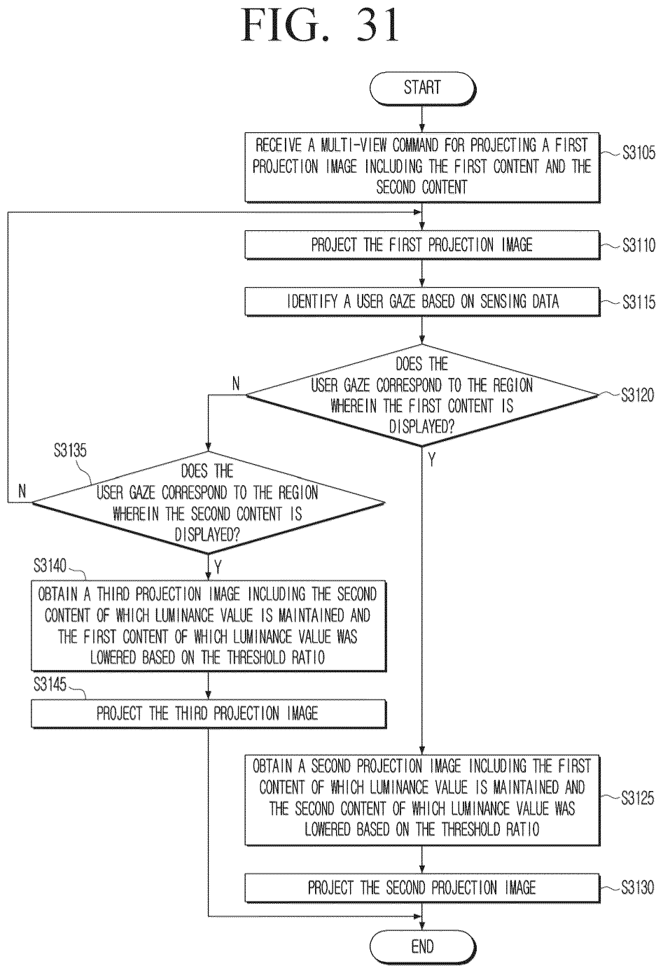

FIG. 31 is a flow chart for illustrating an operation of changing luminance values of some contents as a multi-view function is performed.

Referring to FIG. 31, the electronic device 100 may receive a multi-view command for projecting a first projection image including the first content and the second content in operation S3105. The electronic device 100 may project the first projection image (a merged image) in operation S3110. The electronic device 100 may identify a user gaze based on sensing data in operation S3115.

Here, the electronic device 100 may identify whether the user gaze corresponds to the region wherein the first content is displayed in operation S3120. If the user gaze corresponds to the region wherein the first content is displayed in operation S3120-Y, the electronic device 100 may obtain a second projection image including the first content of which luminance value is maintained and the second content of which luminance value was lowered based on the threshold ratio in operation S3125. The electronic device 100 may project the second projection image in operation S3130.

If the user gaze does not correspond to the region wherein the first content is displayed in operation S3120-N, the electronic device 100 may identify whether the user gaze corresponds to the region wherein the second content is displayed in operation S3135.

If the user gaze corresponds to the region wherein the second content is displayed in operation S3135-Y, the electronic device 100 may obtain a third projection image including the second content of which luminance value is maintained and the first content of which luminance value was lowered based on the threshold ratio in operation S3140. The electronic device 100 may project the third projection image in operation S3145.

If the user gaze does not correspond to the region wherein the second content is displayed in operation S3135-N, the electronic device 100 may project the first projection image. Then, the electronic device 100 may obtain a user gaze in real time, and repeat the operations S3110 to S3145.

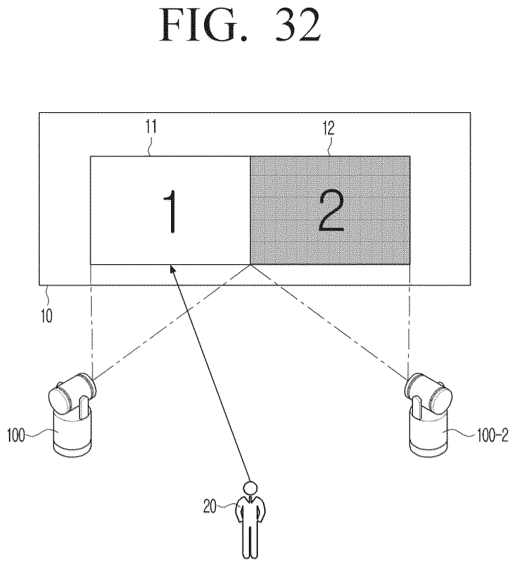

FIG. 32 is a diagram for illustrating an operation of changing luminance values of some contents as a multi-view function is performed with a plurality of devices.

Referring to FIG. 32, the electronic device 100 may project the first content 11, and the external device 100-2 may project the second content 12. Here, projecting the first content 11 and the second content 12 from different devices may also be described as the multi-view function. It is assumed that the user 20 views the projection region wherein the first content 11 is displayed. The electronic device 100 may project the first content 11 to be brighter than the second content 12.

For example, the electronic device 100 may project the first content 11 by maintaining the basic luminance value (100%). Then, the electronic device 100 may generate a control signal for projecting the second content 12 by lowering the luminance value based on the threshold ratio (50%). Then, the electronic device 100 may transmit the generated control signal to the external device 100-2. Here, the control signal may include the corrected second content 12. The external device 100-2 may project the second content 12 received from the electronic device 100.

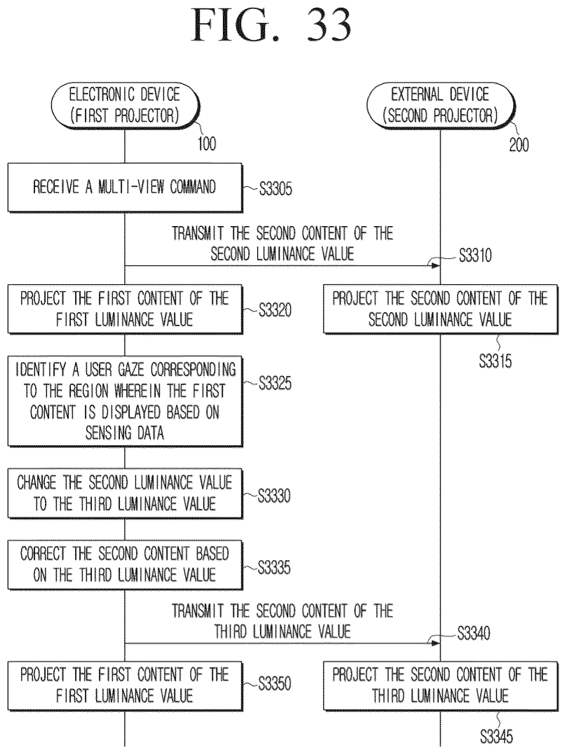

FIG. 33 is a flow chart for illustrating an operation of changing luminance values of some contents as a multi-view function is performed with a plurality of devices.

Referring to FIG. 33, the electronic device 100 may receive a multi-view command in operation S3305. The electronic device 100 may transmit the second content of the second luminance value to the external device 100-2 in operation S3310.

The external device 100-2 may receive the second content of the second luminance value from the electronic device 100. Then, the external device 100-2 may project the second content of the second luminance value in operation S3315.

The electronic device 100 may project the first content of the first luminance value in operation S3320. The electronic device 100 may identify a user gaze corresponding to the first content based on sensing data in operation S3325. For example, the user 20 may view the region wherein the first content is projected. The electronic device 100 may determine that the user 20 is viewing the region wherein the first content is projected by identifying the user gaze.

The electronic device 100 may change the second luminance to the third luminance value. Here, the third luminance value may mean a luminance value that is lower than the second luminance value by the threshold ratio.

The electronic device 100 may correct the second content based on the third luminance value in operation S3335. The electronic device 100 may transmit the second content of the third luminance value to the external device 100-2 in operation S3340.

The external device 100-2 may receive the second content of the third luminance value from the electronic device 100. The external device 100-2 may project the second content of the third luminance value in operation S3345.

The electronic device 100 may project the first content of the first luminance value in operation S3350.

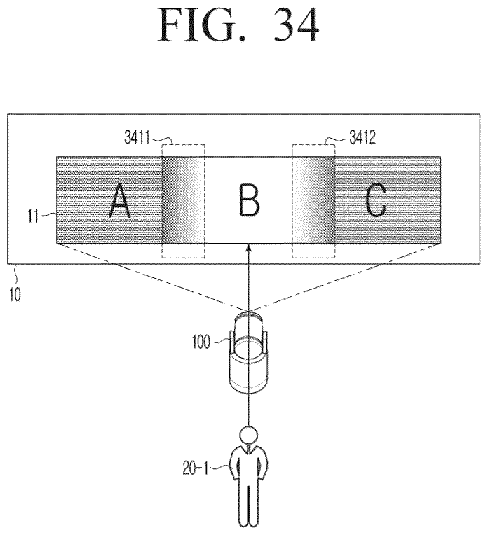

FIG. 34 is a diagram for illustrating an operation of providing a gradation effect to boundaries of divided image regions.

Referring to FIG. 34, the electronic device 100 may divide the entire projection region into a first projection region corresponding to a user gaze and a second projection region not corresponding to the user gaze. Then, the electronic device 100 may divide the entire image region into a first image region corresponding to the first projection region and a second image region corresponding to the second projection region.

Here, the electronic device 100 may provide a gradation effect to the boundary regions 3411, 3412 of the first image region and the second image region. The electronic device 100 may obtain a projection image 11 including the boundary regions 3411, 3412 to which the gradation effect was reflected. In case a gradation effect is included in a boundary between an image region corresponding to a user gaze and an image region not corresponding to the user gaze, the user can accept a luminance difference as natural.

Meanwhile, the electronic device 100 may provide a gradation effect to a boundary of divided image regions. After performing the operations S1510 to S1530 in FIG. 15, the electronic device 100 may identify a boundary region between the first image region of the first luminance value and the second image region of the second luminance value. Then, the electronic device 100 may obtain a projection image wherein the gradation effect generated based on the first luminance value and the second luminance value was reflected on the boundary region. Then, the electronic device 100 may perform the operation S1550 in FIG. 15.

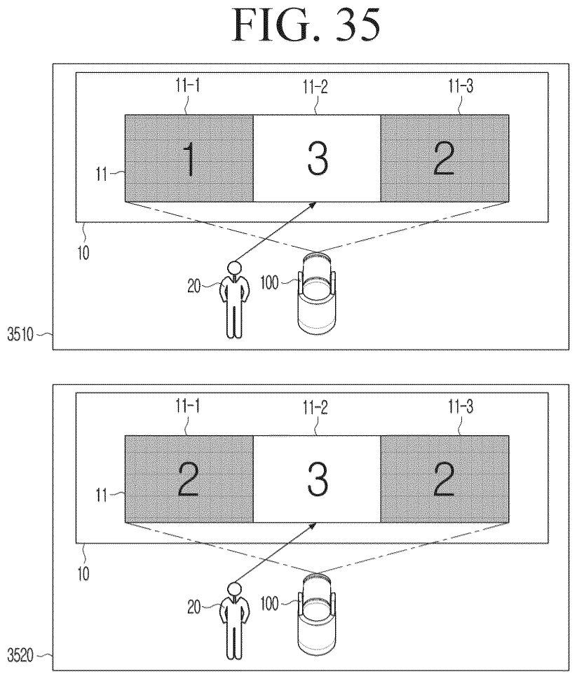

FIG. 35 is a diagram for illustrating an operation of projecting a frame of the current time point and a frame of a past time point simultaneously.

Referring to FIG. 35, the electronic device 100 may project a projection image 11 including both of the current time point and a past time point. The content may include a first frame, a second frame, and a third frame in the order of time. The first frame may be the frame that was projected the earliest, and the third frame may be the frame that was projected the latest. The projection image 11 may include at least two frames among the first frame, the second frame, and the third frame.

Referring to the embodiment 3510 in FIG. 35, it is assumed that the user 20 views the image region 11-2. The electronic device 100 may determine to project the third frame which is the latest frame on the image region 11-2, and project the second frame which is the frame right before based on the current time point on the image region 11-3, and project the first frame which is the previous frame of the second frame on the image region 11-1. Here, the electronic device 100 may project the image region 11-2 to be brighter than the image region 11-1 and the image region 11-3.

For example, the electronic device 100 may maintain the basic luminance value (100%) of the third frame in the image region 11-2 and lower the luminance value of the second frame based on the threshold ratio (50%) in the image region 11-3, and lower the luminance value of the first frame based on the threshold ratio (50%) in the image region 11-1. The electronic device 100 may obtain the projection image 11 including the plurality of image regions 11-1, 11-2, 11-3, and project the projection image 11.

Referring to the embodiment 3520 in FIG. 35, it is assumed that the user 20 views the image region 11-2. The electronic device 100 may determine to project the third frame which is the latest frame on the image region 11-2, and project the second frame which is the frame right before based on the current time point on the image region 11-3, and project the second frame on the image region 11-1. Here, the electronic device 100 may project the image region 11-2 to be brighter than the image region 11-1 and the image region 11-3.

For example, the electronic device 100 may maintain the basic luminance value (100%) of the third frame in the image region 11-2 and lower the luminance value of the second frame based on the threshold ratio (50%) in the image regions 11-1, 11-3. The electronic device 100 may obtain the projection image 11 including the plurality of image regions 11-1, 11-2, 11-3, and project the projection image 11.

Meanwhile, the electronic device 100 may project a frame of the current time point and a frame on a past time point simultaneously.

After performing the operations S1510 to S1530 in FIG. 15, the electronic device 100 may obtain a projection image including the first image region of the first luminance value wherein the second frame of the content is projected and the second image region of the second luminance value wherein the first frame of the content is projected. Here, the first frame may mean a frame that is projected before the second frame.

Afterwards, the electronic device 100 may perform the operation 1550 in FIG. 15.

FIG. 36 is a diagram for illustrating an operation of changing a luminance value by identifying an object.

Referring to FIG. 36, the electronic device 100 may identify a predetermined object 30. Then, the electronic device 100 may correct a projection image 11 based on the predetermined object 30.

Here, the predetermined object may be a ball. The electronic device 100 may identify the moving direction of the predetermined object 30 by analyzing the moving direction of the ball based on sensing data. The electronic device 100 may correct the projection image 10 based on the moving direction of the predetermined object 30.

Referring to the embodiment 3610 in FIG. 36, it is assumed that the predetermined object 30 moved to the image region 11-2. The electronic device 100 may project the image region 11-2 corresponding to the moving direction of the predetermined object 30 to be brighter than the image regions 11-1, 11-3 not corresponding to the moving direction of the predetermined object 30.

For example, the electronic device 100 may maintain the basic luminance value (100%) of the image region 11-2, and lower the luminance values of the image region 11-1 and the image region 11-3 based on the threshold ratio (50%).

Referring to the embodiment 3620 in FIG. 36, it is assumed that the predetermined object 30 is viewing the image region 11-1. The electronic device 100 may project the image region 11-1 corresponding to the moving direction of the predetermined object 30 to be brighter than the image regions 11-2, 11-3 not corresponding to the moving direction of the predetermined object 30.

For example, the electronic device 100 may maintain the basic luminance value (100%) of the image region 11-1, and lower the luminance values of the image region 11-2 and the image region 11-3 based on the threshold ratio (50%).

FIG. 37 is a flow chart for illustrating an operation of changing a luminance value by identifying an object.

The operations S3710, S3720, S3730, S3740, and S3750 in FIG. 37 may correspond to the operations S1510, S1520, S1530, S1540, and S1550 in FIG. 15. Accordingly, overlapping explanation will be omitted.

After a user gaze is identified, the electronic device 100 may identify a projection region in operation S3715. Then, the electronic device 100 may identify whether the user gaze is beyond the projection region in operation S3716. In case the user gaze is not beyond the projection region in operation S3716-N, the electronic device 100 may perform the operations S3720 to S3750.

In case the user gaze is beyond the projection region in operation S3716-Y, the electronic device 100 may determine whether a predetermined object is identified based on sensing data in operation S3717. If the predetermined object is not identified in operation S3717-N, the electronic device 100 may project a projection image in operation S3750.

If the predetermined object is identified in operation S3717-Y, the electronic device 100 may divide a first projection region corresponding to the predetermined object and a second projection region which is the remaining region other than the first projection region in the projection region in operation S3718. Afterwards, the electronic device 100 may perform the operations S3730 to S3750.

FIG. 38 is a diagram for illustrating an operation of changing a luminance value based on a user gesture according to one or more embodiments.

Referring to FIG. 38, the electronic device 100 may identify a user gesture. The electronic device 100 may correct a projection image 11 based on the user gesture. The electronic device 100 may project an image region corresponding to the user gesture to be brighter than the remaining region.

Referring to the embodiment 3810 in FIG. 38, the electronic device 100 may identify a user gaze and a user gesture. It is assumed that the user gaze corresponds to the image region 11-2 and the user gesture corresponds to the image region 11-3.

The electronic device 100 may project the image region 11-2 and the image region 11-3 corresponding to the user gaze to be brighter than the image region 11-1.

For example, the electronic device 100 may maintain the basic luminance value (100%) of the image region 11-2 and the image region 11-3, and lower the luminance value of the image region 11-1 based on the threshold ratio (50%).

Referring to the embodiment 3820 in FIG. 38, the electronic device 100 may identify a user gaze and a user gesture. It is assumed that the user gaze corresponds to the image region 11-2 and the user gesture corresponds to the image region 11-3.

The electronic device 100 may project the image region 11-2 corresponding to the user gaze to be brighter than the image region 11-1 and the image region 11-3.

Also, the electronic device 100 may project the image region 11-3 corresponding to the user gesture to be brighter than the image region 11-1, and to be darker than the image region 11-2.

For example, the electronic device 100 may maintain the basic luminance value (100%) of the image region 11-2 and lower the luminance value of the image region 11-3 based on the first threshold ratio (80%), and lower the luminance value of the image region 11-1 based on the second threshold ratio (50%). The first threshold ratio may be bigger than the second threshold ratio.

Meanwhile, the electronic device 100 may perform an operation of changing a luminance value based on a user gesture according to one or more embodiments.

The electronic device 100 may identify a user gaze and a user gesture based on sensing data. Then, the electronic device 100 may identify a first projection region corresponding to the user gaze. Then, the electronic device 100 may identify a second projection region corresponding to the user gesture.

Afterwards, the electronic device 100 may perform the operations S2923 to S2950 in FIG. 29.

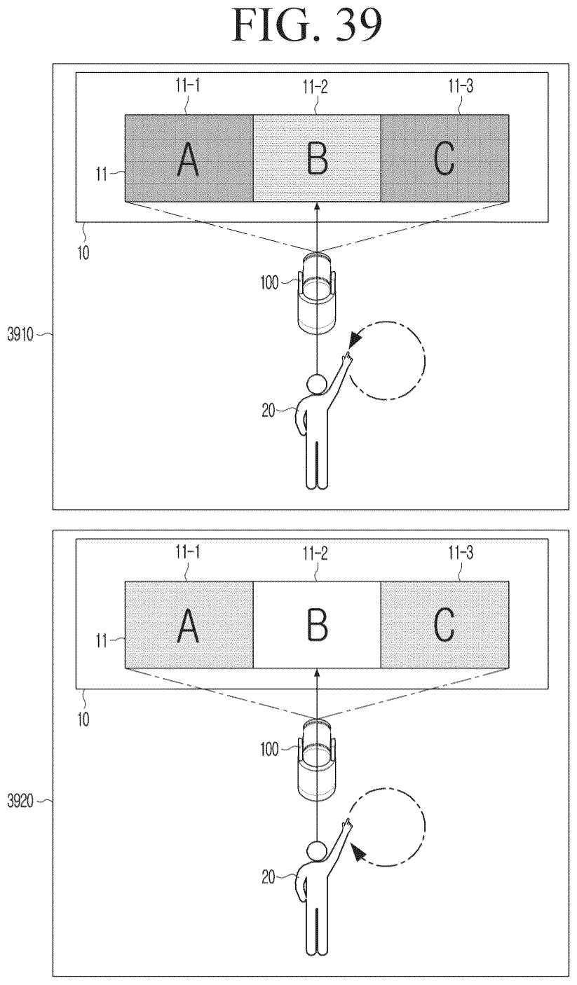

FIG. 39 is a diagram for illustrating an operation of changing a luminance value based on a user gesture according to one or more embodiments.

Referring to the embodiment 3910 in FIG. 39, the electronic device 100 may identify a user gaze and a predetermined user gesture. Here, the electronic device 100 may specify an image region of which luminance value will be changed based on the user gaze, and determine how much the luminance value will be changed based on the predetermined user gesture.

For example, the electronic device 100 may change the luminance value of the region 11-2 corresponding to the user gaze based on the user gesture, and lower the luminance values of the regions 11-1, 11-3 not corresponding to the user gaze based on the threshold ratio (50%).

In case the user gaze corresponds to the image region 11-2, the electronic device 100 may determine to change the luminance value of the image region 11-2. When a user gesture is identified, the electronic device 100 may change the luminance value corresponding to the image region 11-2 based on the user gesture.

If a user gesture rotating a finger in a counter-clockwise direction is identified, the electronic device 100 may lower the luminance value of the image region 11-2 corresponding to the user gaze. Also, if a user gesture rotating a finger in a clockwise direction is identified, the electronic device 100 may heighten the luminance value of the image region 11-2 corresponding to the user gaze.

Referring to the embodiment 3920 in FIG. 39, the electronic device 100 may specify a region 11-2 corresponding to the user gaze based on the user gaze, and change the luminance values of the image regions 11-1, 11-3 not corresponding to the user gaze based on the user gesture.

For example, the electronic device 100 may maintain the luminance value of the region 11-2 corresponding to the user gaze.

For example, the electronic device 100 may maintain the basic luminance value of the region 11-2 corresponding to the user gaze, and change the luminance values of the regions 11-1, 11-3 not corresponding to the user gaze based on the user gesture.

If a user gesture rotating a finger in a clockwise direction is identified, the electronic device 100 may heighten the luminance values of the image regions 11-1, 11-2 not corresponding to the user gaze. If a user gesture rotating a finger in a counter-clockwise direction is identified, the electronic device 100 may lower the luminance values of the regions 11-1, 11-2 not corresponding to the user gaze.

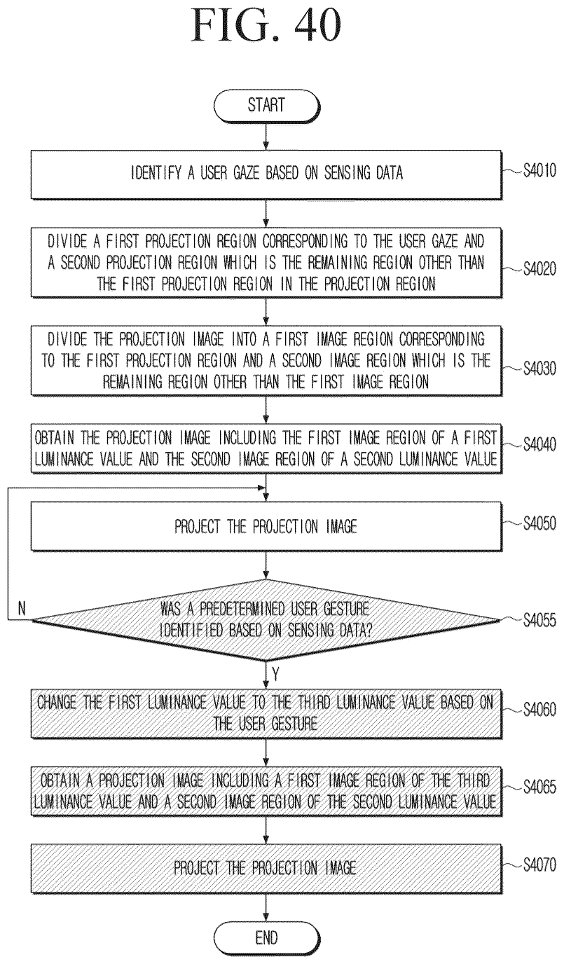

FIG. 40 is a flow chart for illustrating an operation of changing a luminance value based on a user gesture according to one or more embodiments.

The operations S4010, S4020, S4030, S4040, and S4050 in FIG. 40 may correspond to the operations S1510, S1520, S1530, S1540, and S1550 in FIG. 15. Accordingly, overlapping explanation will be omitted.

After the operation S4050, the electronic device 100 may determine whether a predetermined user gesture is identified based on sensing data in operation S4055. If a predetermined user gesture is not identified in operation S4055-N, the electronic device 100 may repeat the operations S4050 to S4055.

If a predetermined user gesture is identified in operation S4055-Y, the electronic device 100 may change the first luminance value to the third luminance value based on the user gesture in operation S4060. Then, the electronic device 100 may obtain a projection image including a first image region of the third luminance value and a second image region of the second luminance value in operation S4065. Then, the electronic device 100 may project the projection image in operation S4070.

FIG. 40 may correspond to an operation related to the embodiment 3910 in FIG. 39.

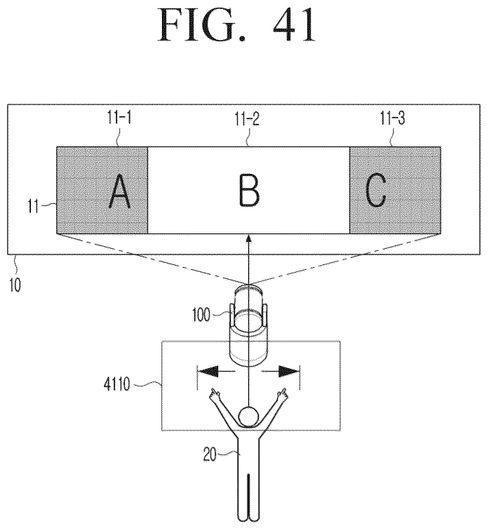

FIG. 41 is a diagram for illustrating an operation of changing a size of a divided image region based on a user gesture.

Referring to FIG. 41, the electronic device 100 may identify a predetermined user gesture 4110. Here, the predetermined user gesture 4110 may be a gesture of moving both hands from the inside to the outside.

The electronic device 100 may change the size of the image region 11-2 corresponding to a user gaze based on the predetermined user gesture 4110. Here, the size of the image region 11-2 may be changed based on the predetermined user gesture 4110.

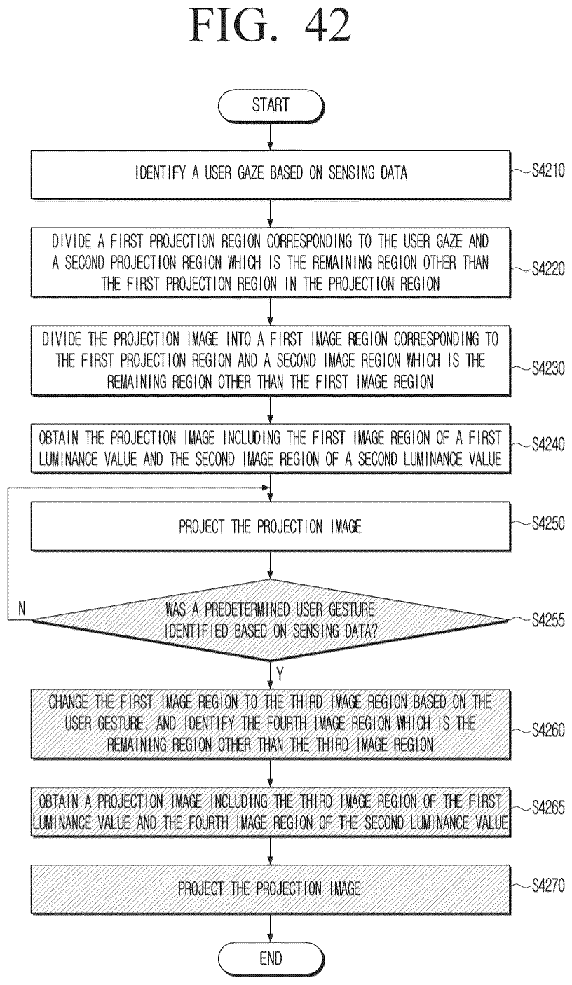

FIG. 42 is a flow chart for illustrating an operation of changing a size of a divided image region based on a user gesture.

The operations S4210, S4220, S4230, S4240, and S4250 in FIG. 42 may correspond to the operations S1510, S1520, S1530, S1540, and S1550 in FIG. 15. Accordingly, overlapping explanation will be omitted.

After the operation S4250, the electronic device 100 may determine whether the predetermined user gesture is identified based on sensing data in operation S4255. If the predetermined user gesture is not identified in operation S4255-N, the electronic device 100 may repeat the operations S4250 to S4255.

If the predetermined user gesture is identified in operation S4255-Y, the electronic device 100 may change the first image region to the third image region based on the user gesture, and identify the remaining region other than the third image region as the fourth image region in operation S4260.

Then, the electronic device 100 may obtain a projection image including the third image region of the first luminance value and the fourth image region of the second luminance value in operation S4265. Then, the electronic device 100 may project the projection image. Here, the third image region may mean the image region 11-2 in FIG. 41. Here, the fourth image region may mean the image regions 11-1, 11-2 in FIG. 41.

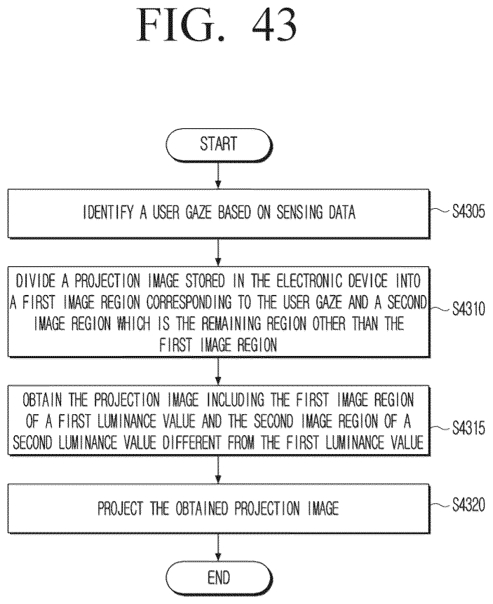

FIG. 43 is a flow chart for illustrating a control method of the electronic device 100 according to one or more embodiments.

Referring to FIG. 43, a control method of the electronic device 100 may include the steps of identifying a user gaze based on sensing data (S4305), dividing a projection image stored in the electronic device 100 into a first image region corresponding to the user gaze and a second image region which is the remaining region other than the first image region (S4310), obtaining the projection image including the first image region of a first luminance value and the second image region of a second luminance value different from the first luminance value (S4315), and projecting the obtained projection image (S4320).

Meanwhile, the control method may further include the steps of identifying a projection region and dividing the projection region into a first projection region corresponding to the user gaze and a second projection region which is the remaining region of the first projection region. Also, in the operation S4310 of dividing the projection image, the projection image may be divided into the first image region corresponding to the first projection region and the second image region corresponding to the second projection region.

Meanwhile, the sensing data may be first sensing data, and the control method may further include the step of identifying the projection region based on second sensing data, and in the step of dividing the projection region, the first projection region may be identified based on a position corresponding to the user gaze and a predetermined distance.

Meanwhile, the first sensing data may be data obtained through an image sensor, and the second sensing data may be data obtained through a distance sensor.

Meanwhile, in the step of dividing the projection region, the projection region may be divided into a plurality of groups, and the plurality of groups may be divided such that a first group corresponding to the user gaze is divided as the first projection region and the remaining group other than the first group is divided as the second projection region.

Meanwhile, the control method may further include the steps of, based on the user gaze not corresponding to the projection region, changing a projection direction based on the user gaze, and reidentifying the projection region based on the changed projection direction.

Meanwhile, the control method may further include the steps of, based on the user gaze not corresponding to the projection region, identifying whether a predetermined object is identified, and based on the predetermined object being identified, identifying a region corresponding to the predetermined object in the projection region as the first projection region.

Meanwhile, the control method may further include the steps of, based on the user gaze being changed, dividing the projection image into a third image region corresponding to the changed user gaze and a fourth image region which is the remaining region other than the third image region, and obtaining the projection image including the third image region of the first luminance value and the fourth image region of the second luminance value.

Meanwhile, the control method may further include the step of, based on identifying a plurality of user gazes including a first user gaze and a second user gaze, obtaining a projection image wherein a luminance value of an image region corresponding to the first user gaze and a luminance value of an image region corresponding to the second user gaze are different.

Meanwhile, the control method may further include the steps of identifying a user gesture based on the sensing data, and obtaining a projection image wherein a luminance value of an image region corresponding to the user gaze and a luminance value of an image region corresponding to the user gesture are different.

Meanwhile, methods according to the aforementioned one or more embodiments of the disclosure may be implemented in forms of applications that can be installed on conventional electronic devices.

Also, the methods according to the aforementioned one or more embodiments of the disclosure may be implemented just with software upgrade, or hardware upgrade of conventional electronic devices.

In addition, the aforementioned one or more embodiments of the disclosure may be performed through an embedded server provided on an electronic device, or an external server of at least one of an electronic device or a display device.

Meanwhile, according to an embodiment of the disclosure, the aforementioned one or more embodiments may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

Also, according to an embodiment of the disclosure, the methods according to the aforementioned one or more embodiments of the disclosure may be provided while being included in a computer program product. A computer program product refers to a product, and it can be traded between a seller and a buyer. A computer program product can be distributed on-line in the form of a storage medium that is readable by machines (e.g.: compact disc read only memory (CD-ROM)), or through an application store (e.g. Play Store™). In the case of on-line distribution, at least a portion of a computer program product may be stored in a storage medium such as the server of the manufacturer, the server of the application store, and the memory of the relay server at least temporarily, or may be generated temporarily.

In addition, each of the components according to the aforementioned one or more embodiments (e.g.: a module or a program) may consist of a singular object or a plurality of objects, and among the aforementioned corresponding sub components, some sub components may be omitted, or other sub components may be further included in the one or more embodiments. Alternatively or additionally, some components (e.g.: a module or a program) may be integrated as an object, and perform functions that were performed by each of the components before integration identically or in a similar manner. Also, operations performed by a module, a program, or other components according to the one or more embodiments may be executed sequentially, in parallel, repetitively, or heuristically. Or, at least some of the operations may be executed in a different order or omitted, or other operations may be added.

Meanwhile, the control method of an electronic device as in FIG. 43 may be executed in an electronic device having the configuration as in FIG. 2 or FIG. 3, or it may be executed in electronic devices having other configurations.

Further, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

What is claimed is:

1. An electronic device comprising:
a projector;
at least one sensor;
at least one processor;
memory storing instructions that, when executed by the at least one processor, cause the at least one processor to:
identify a user gaze based on first sensing data obtained through the at least one sensor;
divide a projection image stored in the memory into a first image region corresponding to the user gaze and a second image region which is a remaining region other than the first image region;
modify the projection image to comprise the first image region of a first luminance value and the second image region of a second luminance value different from the first luminance value; and
control the projector to project the modified projection image.

2. The electronic device of claim 1, wherein the instructions further cause the at least one processor to:
identify a projection region;
divide the projection region into a first projection region corresponding to the user gaze and a second projection region which is a remaining region other than the first projection region; and
divide the projection image into the first image region corresponding to the first projection region and the second image region corresponding to the second projection region.

3. The electronic device of claim 2, wherein the instructions further cause the at least one processor to:
identify the projection region based on second sensing data obtained through the at least one sensor; and
identify the first projection region based on a position corresponding to the user gaze and a predetermined distance.

4. The electronic device of claim 3,
wherein the at least one sensor comprises an image sensor and a distance sensor,
wherein the first sensing data is data obtained through the image sensor, and
wherein the second sensing data is data obtained through the distance sensor.

5. The electronic device of claim 2, wherein the instructions further cause the at least one processor to:
categorize the projection region into a plurality of groups; and
categorize the plurality of groups such that a first group corresponding to the user gaze is categorized as the first projection region and a remaining group other than the first group is categorized as the second projection region.

6. The electronic device of claim 2, wherein the instructions further cause the at least one processor to:
based on the user gaze not corresponding to the projection region, change a projection direction based on the user gaze; and
recategorize the projection region based on the changed projection direction.

7. The electronic device of claim 2, wherein the instructions further cause the at least one processor to:
based on the user gaze not corresponding to the projection region, determine whether a predetermined object is identified; and
based on the predetermined object being identified, categorize a region corresponding to the predetermined object in the projection region as the first projection region.

8. The electronic device of claim 1, wherein the instructions further cause the at least one processor to:
based on the user gaze being changed, divide the projection image into a third image region corresponding to the changed user gaze and a fourth image region which is a remaining region other than the third image region; and
modify the projection image to comprise the third image region of the first luminance value and the fourth image region of the second luminance value.

9. The electronic device of claim 1, wherein the instructions further cause the at least one processor to:
based on identifying a plurality of user gazes comprising a first user gaze and a second user gaze, modify the projection image such that a luminance value of an image region corresponding to the first user gaze and a luminance value of an image region corresponding to the second user gaze are different.

10. The electronic device of claim 1, wherein the instructions further cause the at least one processor to:
identify a user gesture based on the first sensing data; and
modify the projection image such that a luminance value of an image region corresponding to the user gaze and a luminance value of an image region corresponding to the user gesture are different.

11. A method for controlling an electronic device, the method comprising:
identifying a user gaze based on first sensing data;
dividing a projection image stored in the electronic device into a first image region corresponding to the user gaze and a second image region which is a remaining region other than the first image region;
modifying the projection image to comprise the first image region of a first luminance value and the second image region of a second luminance value different from the first luminance value; and
projecting the modified projection image.

12. The method of claim 11, further comprising:
identifying a projection region; and
dividing the projection region into a first projection region corresponding to the user gaze and a second projection region which is a remaining region other than the first projection region, and
wherein the dividing the projection image comprises:
dividing the projection image into the first image region corresponding to the first projection region and the second image region corresponding to the second projection region.

13. The method of claim 12, further comprising:
identifying the projection region based on second sensing data,
wherein the dividing the projection region comprises:
identifying the first projection region based on a position corresponding to the user gaze and a predetermined distance.

14. The method of claim 13,
wherein the first sensing data is obtained through an image sensor, and
wherein the second sensing data is obtained through a distance sensor.

15. The method of claim 12, wherein the dividing the projection region comprises:
categorizing the projection region into a plurality of groups; and
categorizing the plurality of groups such that a first group corresponding to the user gaze is categorized as the first projection region and a remaining group other than the first group is categorized as the second projection region.

16. An electronic device comprising:
a projector;
at least one sensor;
at least one processor;
memory storing instructions that, when executed by the at least one processor, cause the at least one processor to:
identify a user gaze based on first sensing data obtained through the at least one sensor;
based on identifying a first user gaze and a second user gaze, divide a projection image stored in the memory into a first image region corresponding to the first user gaze, a second image region corresponding to the second user gaze, and a third image region which is a remaining region other than the first image region and the second image region;
modify the projection image such that luminance values of the first image region and the second image region are higher than a luminance value of the third image region; and
control the projector to project the modified projection image.
